(19) United States
(12) Patent Application Publication
(10) Pub. No.: US 2011/0027620 A1
(43) Pub. Date: Feb. 3, 2011

(54) RADIATION-CURABLE POLYURETHANE RESIN COMPOSITION AND MAGNETIC RECORDING MEDIUM USING THE SAME

(75) Inventors: Katsumi ARAKI, Odawara-shi (JP); Kazufumi Omura, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/847,333

(22) Filed: Jul. 30, 2010

(30) Foreign Application Priority Data
Jul. 31, 2009 (JP) 2009-179956

(51) Int. Cl. G11B 5/706; C08K 5/45; C08K 5/3435; C08K 5/07; C08K 5/32; G11B 5/73

(52) U.S. Cl. 428/847; 524/83; 524/99; 524/360; 524/259; 428/846

(57) ABSTRACT

An aspect of the present invention relates to a radiation-curable polyurethane resin composition comprising a polyurethane resin containing a radiation-curable functional group and/or starting material compounds thereof, as well as component C in the form of a phenol compound, and component D in the form of at least one compound selected from the group consisting of a piperidine-1-oxyl compound, a nitro compound, a benzoquinone compound and a phenothiazine compound.

### CROSS-REFERENCE TO RELATED APPLICATIONS

This application claims the benefit of priority under 35 USC 119 to Japanese Patent Application No. 2009-179956, filed on Jul. 31, 2009, which is expressly incorporated herein by reference in its entirety.

### BACKGROUND OF THE INVENTION

1. Field of the Invention

The present invention relates to a radiation-curable polyurethane resin composition and to a method of manufacturing the same. More particularly, the present invention relates to a radiation-curable polyurethane resin composition having both good storage stability and curability, and to a method of manufacturing the same.

The present invention further relates to a polyurethane resin formed of the above composition, a magnetic recording medium comprising a radiation-cured layer formed of the above composition, and a storage stabilizer for radiation-curable polyurethane resin.

2. Discussion of the Background

In particulate magnetic recording media, binders play important roles in the dispersibility of magnetic particles, coating durability, electromagnetic characteristics, running durability, and the like. Accordingly, various research has been conducted on binders for magnetic recording media. For example, Japanese Unexamined Patent Publication (KOKAI) No. 2009-96798 or English language family member US2009/087687A1, US2009/258254A1, U.S. Pat. No. 7,737,304 and U.S. Pat. No. 7,737,305, which are expressly incorporated herein by reference in their entirety, propose the use of a binder in the form of a polyurethane resin employing sulfonic acid polyol as a starting material to provide a magnetic recording medium with good running durability dispersibility, coating smoothness, and electromagnetic characteristics.

Conventionally, thermosetting resins and thermoplastic resins such as vinyl chloride resins, polyurethane resins, polyester resins, and acrylic resins have been widely employed as binders in magnetic recording media. In contrast, in recent years, the use of radiation-curable resins incorporating radiation-curable functional groups as binders for magnetic recording media has been proposed to obtain tougher coatings with good productivity. For example, Japanese Unexamined Patent Publication (KOKAI) No. 2000-11353, Japanese Unexamined Patent Publication (KOKAI) No. 2004-63049 or English language family member US2004/072026A1 and U.S. Pat. No. 6,893,723, Japanese Unexamined Patent Publication (KOKAI) No. 2006-202415, Japanese Unexamined Patent Publication (KOKAI) Showa No. 62-107433, which are expressly incorporated herein by reference in their entirety, describe the use of radiation-curable resins as binders for magnetic or nonmagnetic layers. The above-described Japanese Unexamined Patent Publication (KOKAI) No. 2009-96798 also describes the use of a diol having at least one acrylic double bond per molecule to render a polyurethane resin curable by radiation.

Radiation-curable resins are generally synthesized either by using a monomer having a radiation-curable functional group to conduct a polymerization reaction, or by reacting a compound having a radiation-curable functional group with a polymer to introduce a radiation-curable functional group into the side chain of the polymer. These reactions are normally conducted in the presence of a polymerization-inhibiting agent to prevent the radiation-curable functional group from reacting. For example, the above-described Japanese Unexamined Patent Publication (KOKAI) Showa No. 62-107433 describes the use of benzoquinone and the like as a polymerization-inhibiting agent.

On the one hand, the coating liquid is sometimes stored for an extended period of half a year or more in the large-scale production of particulate magnetic recording media. When a radiation-curable binder is employed, the stability of the coating liquid may decrease. This has been attributed to a change in molecular weight due to reaction of the radiation-curable functional group during storage. However, when the quantity of polymerization-inhibiting agent is increased to inhibit reaction of the radiation-curable functional group during storage, the curability during irradiation may decrease, making it difficult to obtain a tough coating.

No means of achieving both long-term storage stability and curability when irradiated with radiation in a radiation-curable binder has been discovered thus far.

### SUMMARY OF THE INVENTION

An aspect of the present invention provides for a radiation-curable resin and a radiation-curable resin composition suited to use in magnetic recording media that have both good storage stability and curability.

The present inventors conducted extensive research into achieving the above radiation-curable resin and resin composition. This resulted in the discovery that by combining a phenol compound and at least one compound selected from the group consisting of a piperidine-1-oxyl compound, a nitro compound, a benzoquinone compound, and a phenothiazine compound with selecting a radiation-curable polyurethane resin among various radiation-curable resins for use, good long-term storage stability could be maintained without loss of curability in radiation-curable resins.

The present invention was devised on that basis.

An aspect of the present invention relates to a radiation-curable polyurethane resin composition comprising a polyurethane resin containing a radiation-curable functional group, and/or starting material compounds thereof, as well as component C in the form of a phenol compound, and component D in the form of at least one compound selected from the group consisting of a piperidine-1-oxyl compound, a nitro compound, a benzoquinone compound and a phenothiazine compound.

The above starting material compounds may comprise component A in the form of an isocyanate compound and component B in the form of a polyol compound, with at least one of components A and B containing a radiation-curable functional group.

The above radiation-curable functional group may be a (meth)acryloyloxy group.

The above component B may comprise a polyol compound with a radiation-curable functional group.

The above component B may comprise a polyol with a sulfonic acid (salt) group.

The above polyol with a sulfonic acid (salt) group may be denoted by the following general formula (1):

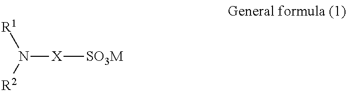

wherein, in general formula (1), X denotes a divalent linking group; each of R¹ and R² independently denotes an alkyl group containing at least one hydroxyl group and equal to or more than two carbon atoms or an aralkyl group containing at least one hydroxyl group and equal to or more than eight carbon atoms; and M denotes a hydrogen atom or a cation.

The above polyurethane resin composition may comprise component C in a quantity of equal to or higher than 500 ppm but equal to or lower than 100,000 ppm and component D in a quantity of equal to or higher than 1 ppm but equal to or lower than 500 ppm, relative to the polyurethane resin.

The above polyurethane resin composition may be used as a coating liquid for forming a magnetic recording medium or used for preparing the coating liquid.

A further aspect of the present invention relates to a method of manufacturing the above radiation-curable polyurethane resin composition, which comprises conducting a reaction of component A and component B in the presence of component C.

The above method may further comprise mixing a product of the reaction with component D.

A still further aspect of the present invention relates to a polyurethane resin obtained by radiation-curing the above radiation-curable polyurethane resin composition.

A still further aspect of the present invention relates to a magnetic recording medium comprising a magnetic layer containing a ferromagnetic powder and a binder on a nonmagnetic support, which comprises at least one radiation-cured layer obtained by radiation-curing a coating layer comprising the above radiation-curable polyurethane resin composition.

In the above magnetic recording medium, the radiation-cured layer may be the magnetic layer.

The above magnetic recording medium may comprise a nonmagnetic layer containing a nonmagnetic powder and a binder between the nonmagnetic support and the magnetic layer and the nonmagnetic layer may be the radiation-cured layer.

A still further aspect of the present invention relates to a storage stabilizer for a radiation-curable polyurethane resin comprising a phenol compound and at least one compound selected from the group consisting of a piperidine-1-oxyl compound, a nitro compound, a benzoquinone compound and a phenothiazine compound.

The present invention can provide a radiation-curable polyurethane resin composition, having good long-term storage stability and good curability (a good crosslinking property) when irradiated with radiation, that is suited to use in magnetic recording media.

The radiation-curable polyurethane resin composition of the present invention can exhibit good curability when irradiated with radiation and is capable of forming a coating layer such as a magnetic layer or nonmagnetic layer of good coating strength even when used to form such a coating layer after extended storage. In contrast to the extended period of thermoprocessing that is required to cure the coating when a thermosetting resin is employed as binder in a magnetic recording medium, the coating can be cured by a short period of irradiation with a radiation-curable resin, which is advantageous from the perspective of productivity.

Other exemplary embodiments and advantages of the present invention may be ascertained by reviewing the present disclosure.

### DETAILED DESCRIPTION OF THE EMBODIMENTS

Unless otherwise stated, a reference to a compound or component includes the compound or component by itself, as well as in combination with other compounds or components, such as mixtures of compounds.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

The following preferred specific embodiments are, therefore, to be construed as merely illustrative, and non-limiting to the remainder of the disclosure in any way whatsoever. In this regard, no attempt is made to show structural details of the present invention in more detail than is necessary for fundamental understanding of the present invention; the description taken with the drawings making apparent to those skilled in the art how several forms of the present invention may be embodied in practice.

### Radiation-Curable Polyurethane Resin Composition

The radiation-curable polyurethane resin composition of the present invention (also referred to simply as the “resin composition” or “composition” hereinafter) comprises a polyurethane resin containing a radiation-curable functional group (also referred to as “radiation-curable polyurethane resin” hereinafter) and/or starting material compounds thereof, and components C and D below.

Component C: a phenol compound

Component D: at least one compound selected from the group consisting of a piperidine-1-oxyl compound, a nitro compound, a benzoquinone compound, and a phenothiazine compound.

As set forth above, although it has conventionally been difficult to achieve both of the seemingly mutually exclusive properties of curability when irradiated with radiation and long-term storage stability in a radiation-curable binder, the storage stability of a radiation-curable polyurethane resin can be maintained for extended periods without loss of curability by incorporating components C and D in the present invention.

In the resin composition of the present invention, it suffices to incorporate at least the above components. However, various components commonly employed in polyurethane synthesis can be selectively included, such as solvents, polymerization initiators and catalysts, in addition to the above components.

Further, the resin composition of the present invention may be in a single-liquid form with all the components being contained in a single liquid; a two liquid form in which a first liquid and a second liquid are successively combined during use; or a multiple liquid form of three or more liquids. For example, as set forth below, the starting materials of the radiation-curable polyurethane resin can be mixed with component C and subjected in this state to a synthesis reaction to form a radiation-curable polyurethane resin, with component D being added after the synthesis reaction.

The various components of the radiation-curable polyurethane resin composition of the present invention will be described in greater detail below.

### (i) Radiation-Curable Polyurethane Resin and Its Starting Materials

The radiation-curable functional group that is present in the radiation-curable polyurethane resin can be any functional group that undergoes a curing reaction (crosslinking reaction) when irradiated with radiation; it is not specifically limited. From the perspective of reactivity, a group with a radical polymerizable carbon-carbon double bond is desirable and an acrylic double bond group is preferred. In this context, the term “acrylic double bond group” refers to a residue of acrylic acid, acrylic acid ester, amide acrylate, methacrylic acid, methacrylic acid ester, or amide methacrylate. Of these, from the perspective of reactivity, a (meth)acryloyloxy group is desirable. In the present invention, the term “(meth)acryloyloxy group” includes methacryloyloxy groups and acryloyloxy groups, and the term “(meth)acrylate” includes methacrylates and acrylates.

The resin composition of the present invention can contain a radiation-curable polyurethane resin itself, or the starting materials of a radiation-curable polyurethane resin. Examples of the starting materials of a radiation-curable polyurethane resin are isocyanate compounds, polyol compounds, and radiation-curable functional group-containing compounds. The radiation-curable polyurethane resin can be in the form of either (A-1) or (A-2) below.

(A-1): A radiation-curable polyurethane resin obtained by using a polymerization reaction to incorporate a radiation-curable functional group as a side chain into a polyurethane resin in the form of the urethane-forming reaction product of an isocyanate compound and a polyol compound.

(A-2): A radiation-curable polyurethane resin obtained using at least an isocyanate compound or a polyol compound in the form of a compound having a radiation-curable functional group.

In form (A-1), examples of the compound employed to incorporate a radiation-curable functional group are compounds containing carbon-carbon double bond groups such as (meth)acrylic acid, glycidyl (meth)acrylate, hydroxyalkyl (meth)acrylate, and 2-isocyanatoethyl (meth)acrylate. Taking into account the simplicity of synthesis, cost, and starting material availability, form (A-2) is desirable. Form (A-2) will be described in greater detail below.

Components A and B are employed as starting material compounds in form (A-2).

Compound A: Isocyanate compound

Compound B: Polyol compound

(At least component A or component B contains a radiation-curable functional group.)

The radiation-curable functional group can be contained in either component A or component B, or in both. Taking into account the availability and cost of starting materials, the use of a polyol compound containing a radiation-curable functional group as component B is desirable.

Components A and B will be described in greater detail below.

### Component A

The term “isocyanate compound” means a compound having an isocyanate group. The use of a bifunctional or greater polyfunctional isocyanate compound (referred to as a “polyisocyanate” hereinafter) as component A is desirable. Polyisocyanates that can be employed as component A are not specifically limited; any known polyisocyanate can be employed. For example, diisocyanates such as trilene diisocyanate (TDI), diphenylmethane diisocyanate (MDI), p-phenylene diisocyanate, o-phenylene diisocyanate, m-phenylene diisocyanate, xylylene diisocyanate, hydrogenated xylylene diisocyanate, and isophorone diisocyanate can be employed. One isocyanate compound may be employ singly or two or more isocyanate compounds may be employed in combination as component A.

### Component B

A polyol is a compound comprising two or more hydroxyl groups per molecule. One polyol compound may be employed singly, or two or more polyol compounds may be employed in combination as component B. When employing two or more polyol compounds in combination, at least one of the polyol compounds employed desirably comprises a radiation-curable functional group.

Diols having at least one acrylic double bond per molecule, such as glycerin monoacrylate (also known as glycerol acrylate), glycerin monomethacrylate (also known as glycerol methacrylate) (such as Blemmer GLM, a trade name of NOF Corp.), and bisphenol A epoxyacrylate (such as Epoxyester 3000A, a trade name of Kyoeisha Chemical Co., Ltd.), are suitable as the above polyol compound comprising a radiation-curable functional group. Among these diols, the compound indicated below (glycerin mono(meth)acrylate) is desirable for the effect achieved in combination with components C and D. Below, R¹ denotes a hydrogen atom or methyl group.

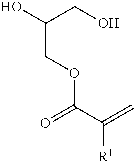

Polar groups are commonly incorporated into binders for magnetic recording media to increase the dispersion of magnetic powder, nonmagnetic powder, and the like. Polar groups are also desirably incorporated into the above radiation-curable polyurethane resin to enhance dispersion. Examples of polar groups are hydroxyalkyl groups, carboxylic acid (salt) groups, sulfonic acid (salt) groups, sulfuric acid (salt) groups, and phosphoric acid (salt) groups. In the present invention, the term “sulfonic acid (salt) groups” includes the sulfonic acid group (—SO₃H) and sulfonate groups such as —SO₃Na, —SO₃Li, and —SO₃K. The same holds true for carboxylic acid (salt) groups, sulfuric acid (salt) groups, phosphoric acid (salt) groups, and the like.

In the resin composition of the present invention, to incorporate the above polar group, a polar group-containing polyol compound is desirably included in component B. Polyol compounds obtained by incorporating the polar groups into the various polyols described further below can be employed as the polar group-containing polyol compound. The sulfonic acid (salt) group-containing polyol compound denoted by general formula (1) below is an example of a suitable polar group-containing polyol compound. Normally, the polyurethane synthesis reaction is conducted in an organic solvent. However, sulfonic acid (salt) group-containing polyol compounds generally have poor solubility in organic solvents, and thus have poor reactivity. By contrast, the polyol compound denoted by general formula (1) is suitable as a starting material compound for polyurethane due to good solubility in organic solvents. As is set forth in Examples described further below, by storing the radiation-curable polyurethane resin compositions obtained using the polyol compound denoted by general formula (1) as a starting material compound in the presence of components C and D, long-term, stable storage can be achieved and good curability can be exhibited when irradiated with radiation.

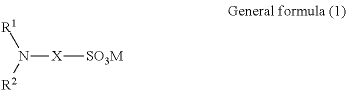

In general formula (1), X denotes a divalent linking group; each of R¹ and R² independently denotes an alkyl group containing at least one hydroxyl group and equal to or more than two carbon atoms or an aralkyl group containing at least one hydroxyl group and equal to or more than eight carbon atoms; and M denotes a hydrogen atom or a cation.

Details of general formula (1) will be described below.

In general formula (1), X denotes a divalent linking group and desirably a divalent hydrocarbon group; an alkylene group, arylene group, or a combination of two or more of these groups is preferred; an alkylene group or an arylene group is of greater preference; an ethylene group or a phenylene group is of still greater preference; and an ethylene group is optimal.

Examples of the phenylene group are o-phenylene, m-phenylene, and p-phenylene groups. An o-phenylene or m-phenylene group is desirable, and an m-phenylene group is preferred.

The above alkylene group desirably comprises equal to or more than 2 but equal to or less than 20, preferably equal to or more than 2 but equal to or less than 4, and more preferably 2, carbon atoms. The alkylene group may be a linear alkylene group or branched alkylene group; a linear alkylene group is desirable.

The above arylene group desirably comprises equal to or more than 6 but equal to or less than 20, preferably equal to or more than 6 but equal to or less than 10, and more preferably 6, carbon atoms.

The above alkylene group and arylene group may comprise the following substituent, but are desirable comprised of just carbon atoms and hydrogen atoms.

Examples of substituents that are optionally present on the alkylene group are: aryl groups, halogen atoms (fluorine, chlorine, bromine, and iodine atoms), alkoxy groups, aryloxy groups, and alkyl groups.

Examples of substituents that are optionally present on the arylene group are: alkyl groups, halogen atoms (fluorine, chlorine, bromine, and iodine atoms), alkoxy groups, aryloxy groups, and aryl groups.

In general formula (1), each of R¹ and R² independently denotes an alkyl group comprising at least one hydroxyl group and equal to or more than two carbon atoms or an aralkyl group comprising at least one hydroxyl group and equal to or more than eight carbon atoms. The alkyl group and aralkyl group may have substituents other than hydroxyl groups.

In addition to hydroxyl groups, the above alkyl group and aralkyl group may comprise substituents in the form of alkoxy groups, aryloxy groups, halogen atoms (fluorine, chlorine, bromine, and iodine atoms), sulfonyl groups, and silyl groups, for example. Of these, alkoxy groups and aryloxy groups are desirable; alkoxy groups having 1 to 20 carbon atoms and aryloxy groups having 6 to 20 carbon atoms are preferred; and phenoxy groups and alkoxy groups having 1 to 4 carbon atoms are of greater preference.

These alkyl groups and aralkyl groups may be linear or branched.

One or more hydroxyl groups are contained, 1 or 2 are desirable, and 1 is preferred, in each of R¹ and R². That is, the sulfonic acid (salt) group-containing polyol denoted by general formula (1) is preferably a sulfonic acid (salt) group-containing diol compound.

From the perspective of solubility in organic solvents, availability of starting materials, cost and the like, the alkyl group in R¹ and R² comprises equal to or more than 2, desirably 2 to 22, preferably 3 to 22, more preferably 4 to 22, and still more preferably 4 to 8 carbon atoms.

From the perspective of solubility in organic solvents, availability of starting materials, cost and the like, the aralkyl group in R¹ and R² comprises equal to or more than 8, desirably 8 to 22, preferably 8 to 12, and more preferably, 8 carbon atoms.

In the aralkyl group contained in R¹ and R², saturated hydrocarbon chains are desirably present at the α-position and β-position of the nitrogen atom. In that case, a hydroxyl group may be present at the β-position of a nitrogen atom.

In R¹ and R², a hydroxyl group is desirably not present at the α-position of a nitrogen atom, one hydroxyl group is desirably present at the least the β-position of a nitrogen atom, and a single hydroxyl group is preferably present at the β-position of a nitrogen atom. The presence of a hydroxyl group at the β-position of a nitrogen atom can facilitate synthesis and enhance solubility in organic solvents.

Each of R¹ and R² independently preferably denotes an alkyl group comprising at least one hydroxyl group and 2 to 22 carbon atoms, an aralkyl group comprising at least one hydroxyl group and 8 to 22 carbon atoms, an alkoxyalkyl group comprising at least one hydroxyl group and 3 to 22 carbon atoms, or an aryloxyalkyl group comprising at least one hydroxyl group and 9 to 22 carbon atoms. An alkyl group comprising at least one hydroxyl group and 2 to 20 carbon atoms, an aralkyl group comprising at least one hydroxyl group and 8 to 20 carbon atoms, an alkoxyalkyl group comprising at least one hydroxyl group and 3 to 20 carbon atoms, or an aryloxyalkyl group comprising at least one hydroxyl group and 9 to 20 carbon atoms is preferred.

Specific examples of alkyl groups comprising at least one hydroxyl group and equal to or more than two carbon atoms are: 2-hydroxyethyl groups, 2-hydroxypropyl groups, 2-hydroxybutyl groups, 2-hydroxypentyl groups, 2-hydroxyhexyl groups, 2-hydroxyoctyl groups, 2-hydroxy-3-methoxypropyl groups, 2-hydroxy-3-ethoxypropyl groups, 2-hydroxy-3-butoxypropyl groups, 2-hydroxy-3-phenoxypropyl groups, 2-hydroxy-3-methoxybutyl groups, 2-hydroxy-3-methoxy-3-methylbutyl groups, 2,3-dihydroxypropyl groups, 3-hydroxypropyl groups, 3-hydroxybutyl groups, 4-hydroxybutyl groups, 1-methyl-2-hydroxyethyl groups, 1-ethyl-2-hydroxyethyl groups, 1-propyl-2-hydroxyethyl groups, 1-butyl-2-hydroxyethyl groups, 1-hexyl-2-hydroxyethyl groups, 1-methoxymethyl-2-hydroxyethyl groups, 1-ethoxymethyl-2-hydroxyethyl groups, 1-butoxymethyl-2-hydroxyethyl groups, 1-phenoxymethyl-2-hydroxyethyl groups, 1-(1-methoxyethyl)-2-hydroxyethyl groups, 1-(1-methoxy-1-methyl ethyl)-2-hydroxyethyl groups, and 1,3-dihydroxy-2-propyl groups. Of these, 2-hydroxybutyl groups, 2-hydroxy-3-methoxypropyl groups, 2-hydroxy-3-butoxypropyl groups, 2-hydroxy-3-phenoxypropyl groups, 1-methyl-2-hydroxyethyl groups, 1-methoxymethyl-2-hydroxyethyl groups, 1-butoxymethyl-2-hydroxyethyl groups, and 1-phenoxyethyl-2-hydroxyethyl groups are desirable examples.

Specific examples of aralkyl groups comprising at least one hydroxyl group and equal to or more than eight carbon atoms are: 2-hydroxy-2-phenylethyl groups, 2-hydroxy-2-phenylpropyl groups, 2-hydroxy-3-phenylpropyl groups, 2-hydroxy-2-phenylbutyl groups, 2-hydroxy-4-phenylbutyl groups, 2-hydroxy-5-phenylp entyl groups, 2-hydroxy-2-(4-methoxyphenyl)ethyl groups, 2-hydroxy-2-(4-phenoxyphenyl)ethyl groups, 2-hydroxy-2-(3-methoxyphenyl)ethyl groups, 2-hydroxy-2-(4-chlorophenyl)ethyl groups, 2-hydroxy-2-(4-hydroxyphenyl)ethyl groups, 2-hydroxy-3-(4-methoxyphenyl)propyl groups, 2-hydroxy-3-(4-chlorophenyl)propyl groups, 1-phneyl-2-hydroxyethyl groups, 1-methyl-1-phenyl-2-hydroxyethyl groups, 1-benzyl-2-hydroxyethyl groups, 1-ethyl-1-phenyl-2-hydroxyethyl groups, 1-phenethyl-2-hydroxyethyl groups, 1-phenylpropyl-2-hydroxyethyl groups, 1-(4-methoxyphenyl)-2-hydroxyethyl groups, 1-(4-phenoxyphenyl)-2-hydroxyethyl groups, 1-(3-methoxyphenyl)-2-hydroxyethyl groups, 1-(4-chlorophenyl)-2-hydroxyethyl groups, 1-(4-hydroxyphenyl)-2-hydroxyethyl groups, and 1-(4-methoxyphenyl)-3-hydroxy-2-propyl groups. Of these, 2-hydroxy-2-phenylethyl groups and 1-phenyl-2-hydroxyphenyl groups are desirable examples.

In general formula (1), M denotes hydrogen atom or a cation.

The cation may be an inorganic cation or an organic cation. The cation electrically neutralizes the —SO₃⁻ in general formula (1). It is not limited to a monovalent cation, and can be a divalent or greater cation. A monovalent cation is desirable. When the valence of the cation denoted by M is given by n, M denotes (1/n) moles of the cation relative to the compound denoted by general formula (1).

The inorganic cation is not specifically limited; desirable examples are alkali metal ions and alkaline earth metal ions. Alkali metal ions are preferred examples, and Li⁺, Na⁺, K⁺, Rb⁺, and Cs⁺ are examples of greater preference.

Examples of organic cations are ammonium ions, quaternary ammonium ions, and pyridinium ions.

The above M is desirably a hydrogen atom or an alkali metal ion, preferably a hydrogen atom, Li⁺, Na⁺, or K⁺, and further preferably, K⁺.

The compound denoted by general formula (1) may comprise one or more aromatic ring within the molecule to enhance solubility in organic solvents.

In general formula (1), R¹ and R² may be identical or different, but are desirably identical to facilitate synthesis.

In formula (1), each of R¹ and R² desirably denotes a group with equal to or more than five carbon atoms. In general formula (1), each of R¹ and R² is desirably a group comprising an aromatic ring and/or an ether bond.

Reference can be made to Japanese Unexamined Patent Publication (KOKAI) No. 2009-96798, which is expressly incorporated herein by reference in its entirety, for the details of the above-described polyol compound denoted by general formula (1). In particular, reference can be made to [0028], [0029] [0045] and Examples of Japanese Unexamined Patent Publication (KOKAI) No. 2009-96798, for the synthesis method of the polyol compound denoted by general formula (1). In addition, examples of the polyol compound denoted by general formula (1) include the compounds denoted by general formulas (2) and (3) described in Japanese Unexamined Patent Publication (KOKAI) No. 2009-9679, and details thereof are described in [0030] to [0034] of Japanese Unexamined Patent Publication (KOKAI) No. 2009-9679. Specific examples of the polyol compound denoted by general formula (1) are the following Example compounds (S-1) to (S-70) described in Japanese Unexamined Patent Publication (KOKAI) No. 2009-9679 and the following Example compounds (S-71) to (S-74). In Example compounds below, “Ph” denotes a phenyl group and “Et” denotes an ethyl group.

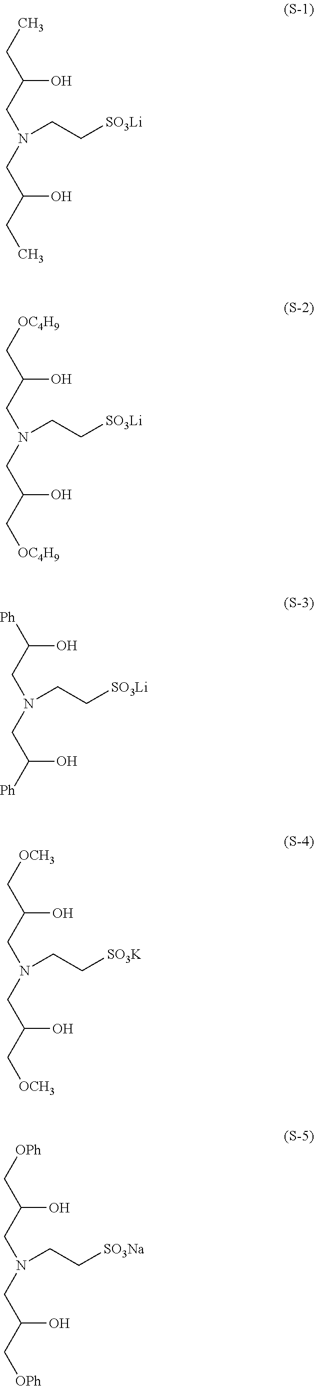

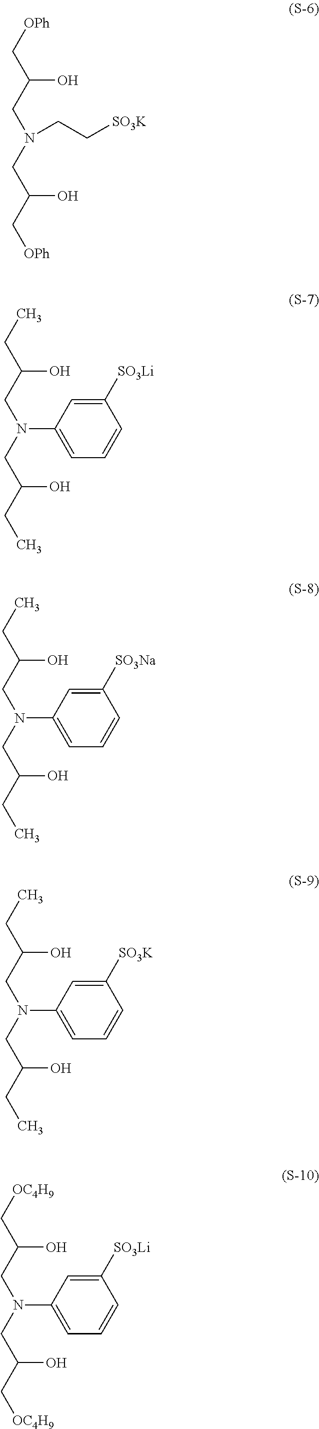

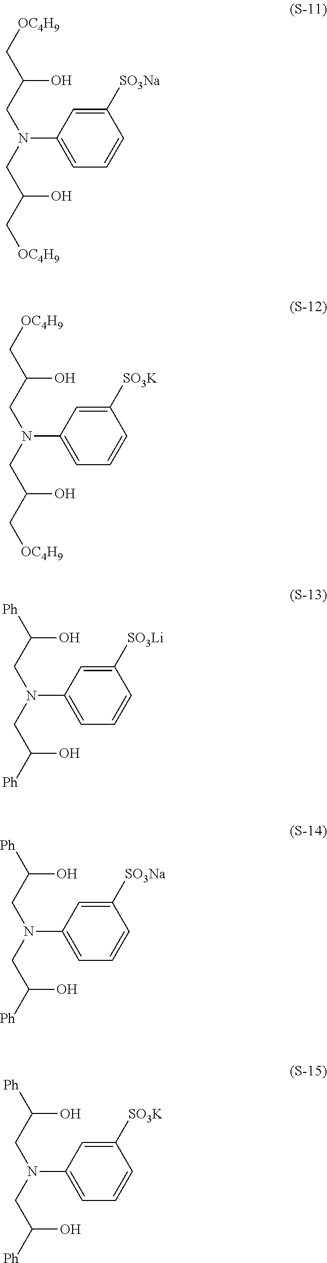

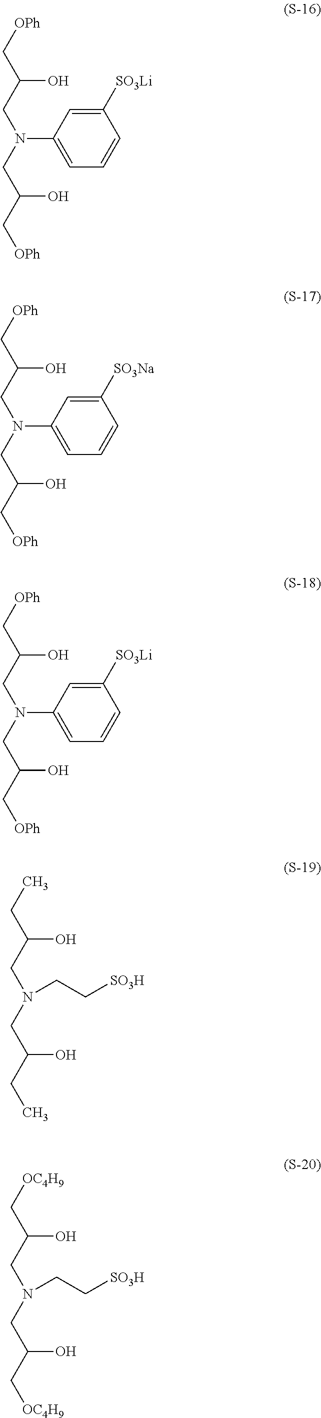

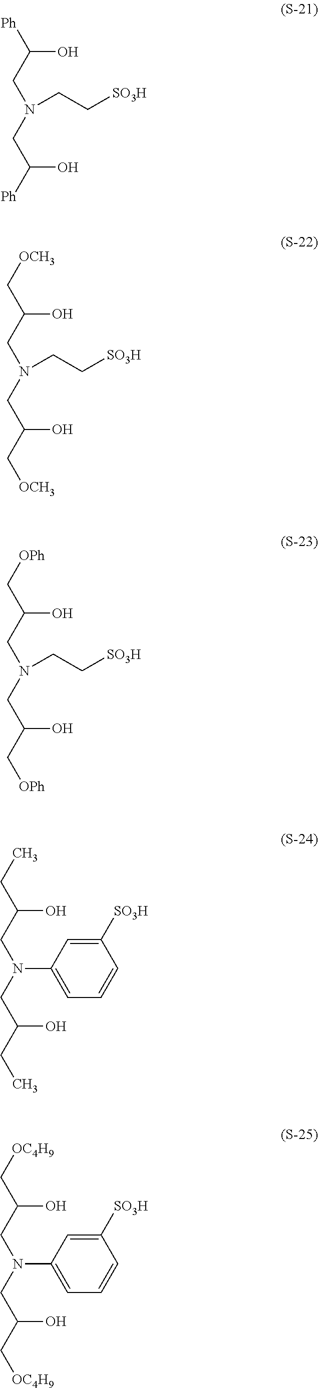

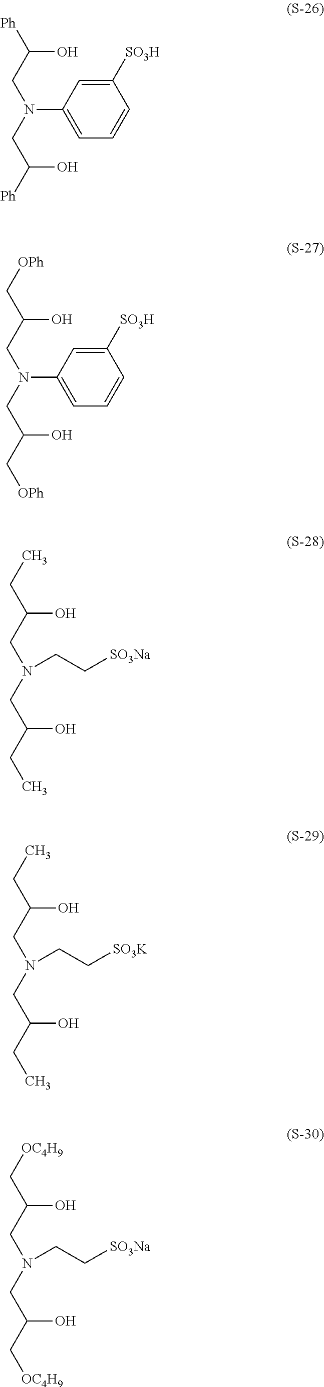

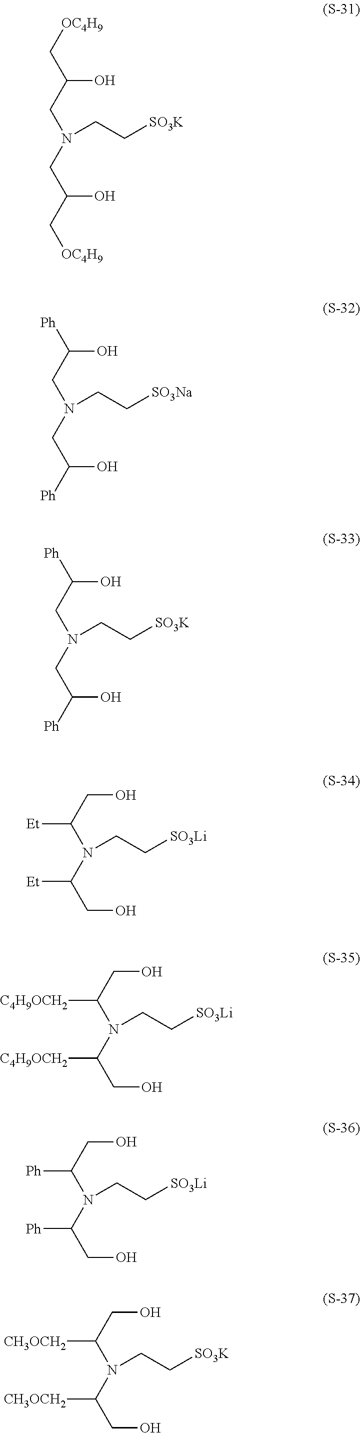

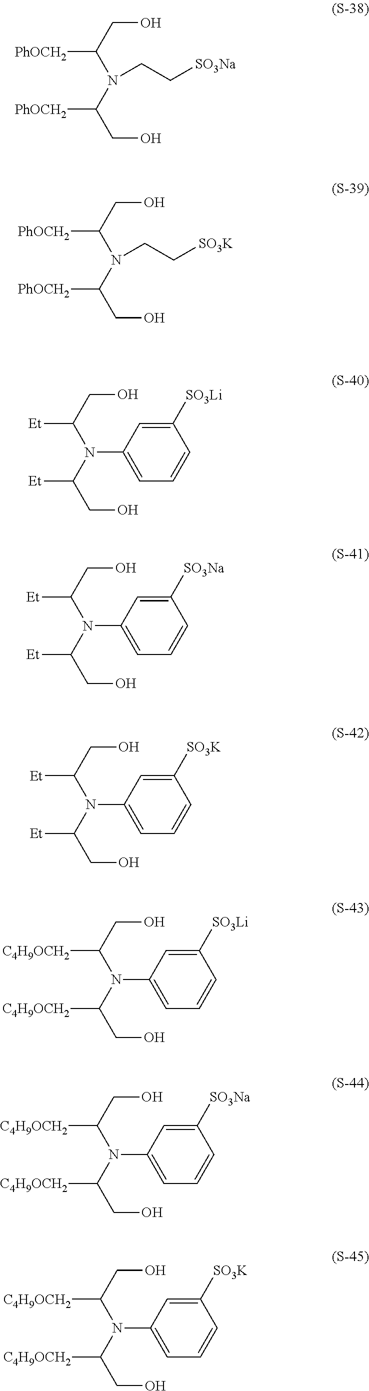

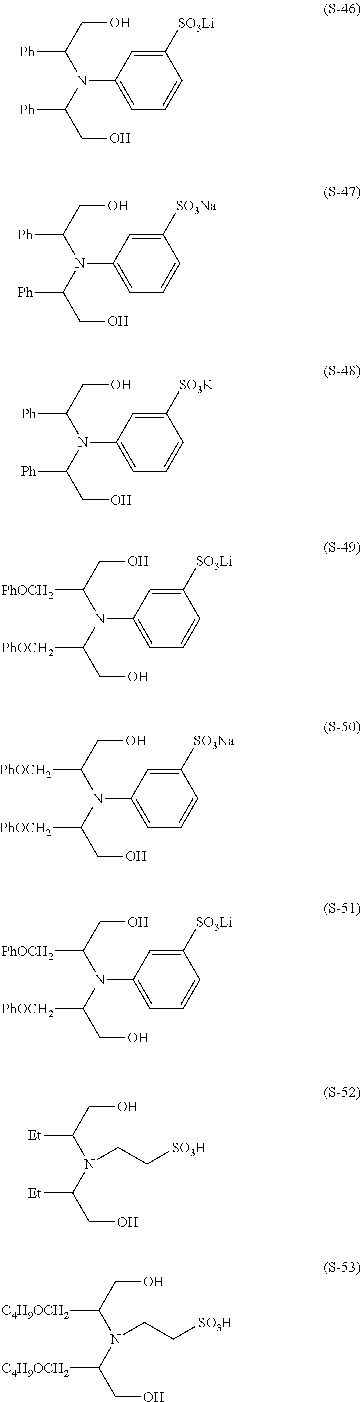

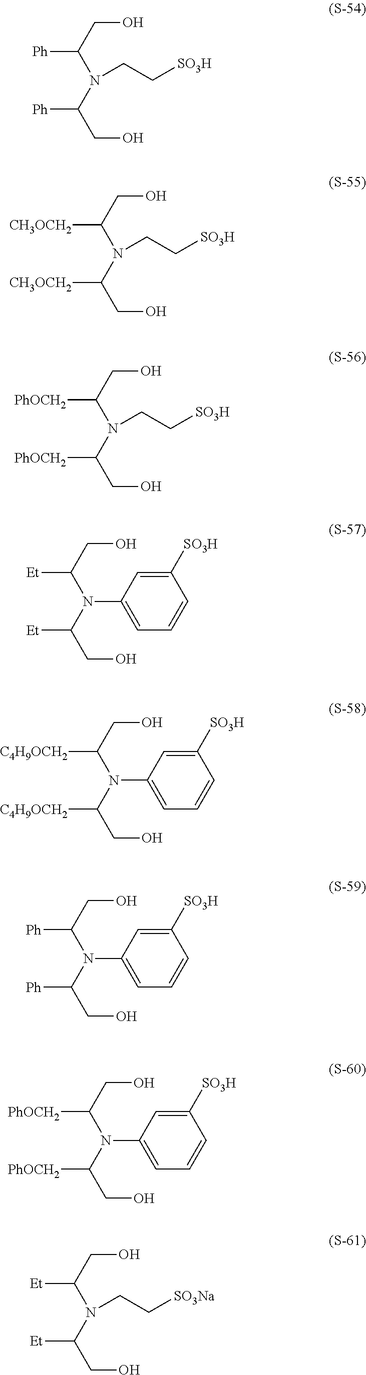

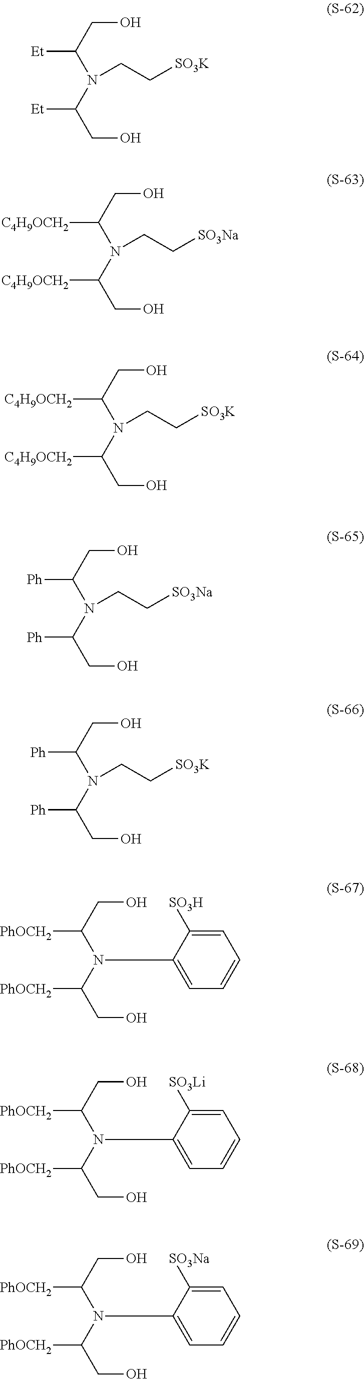

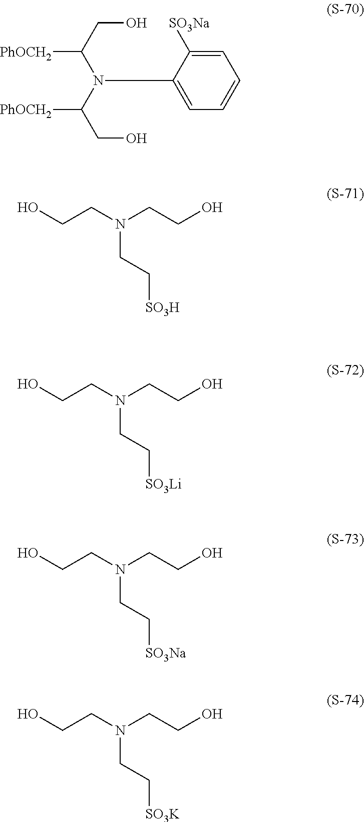

Known polyol compounds that are commonly employed as chain-extending agents in polyurethane synthesis, such as polyester polyols, polyether polyols, polyetherester polyols, polycarbonate polyols, polyolefin polyols, and dimer diols, can be employed as the polyol compound. Of these, polyester polyols and polyether polyols are desirable.

Polyester polyols obtained by the polycondensation of a polycarboxylic acid (polybasic acid) and a polyol, and those obtained by reacting a dibasic acid (such as a dicarboxylic acid) and a diol, are desirably employed as the polyester polyol. The dibasic acid components that can be employed in the polyester polyol are not specifically limited. Adipic acid, azelaic acid, phthalic acid, sodium sulfoisophthalic acid, and the like are desirable. Diols having branched side chains, such as 2,2-dimethyl-1,3-propanediol, 2-ethyl-2-butyl-1,3-propanediol, and 3-methyl-1,5-pentanediol are desirable as the diol.

Polyether polyols having cyclic structures, such as polypropylene oxide adducts of bisphenol A and polyethylene oxide adducts of bisphenol A are desirable as polyether polyols.

Known short-chain diols having a molecular weight of about 100 to 500 may be employed as needed as polyol compounds. Of these, aliphatic diols having branched side chains with two or more carbon atoms, ether compounds with cyclic structures, short-chain diols with bridged hydrocarbon structures, and short-chain diols having spiro structures are desirable.

Specific examples of aliphatic diols having branched side chains with two or more carbon atoms are the various compounds described in [0059] of Japanese Unexamined Patent Publication (KOKAI) No. 2009-96798. Of these, 2-ethyl-2-butyl-1,3-propanediol and 2,2-diethyl-1,3-propanediol are desirable.

Examples of ether compounds having cyclic structures are ethylene oxide adducts of bisphenol A, propylene oxide adducts of bisphenol A, ethylene oxide adducts of hydrogenated bisphenol A, propylene oxide adducts of hydrogenated bisphenol A, and the fluorene-derived alcohols denoted by the following formula.

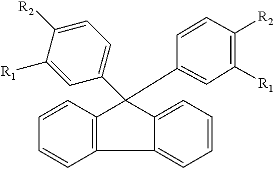

(In the formula, R₁ denotes H or CH₃, R₂ denotes OH or —OCH₂CH₂OH, and the two instances of R₁ and of R₂ may be identical or different.)

The bridged hydrocarbon structure or spiro structure is desirably at least one of the structures selected from the group consisting of formulas (a) to (c) below.

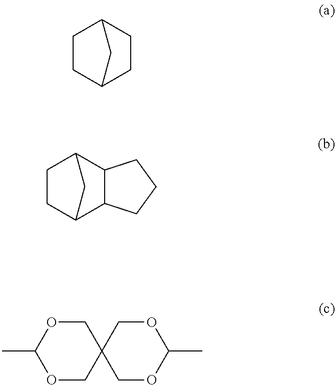

Specific examples of short-chain diols having bridged hydrocarbon structures are the various compounds described in [0063] of Japanese Unexamined Patent Publication (KOKAI) No. 2009-96798. Of these, tricyclo[5.2.1.0^{2.6}]decanedimethanol is desirable.

Specific examples of short-chain diols having spiro structures are the various compounds described in [0064] of Japanese Unexamined Patent Publication (KOKAI) No. 2009-96798. Of these, bis(1,1-dimethyl-2-hydroxyethyl)-2,4,8,10-tetraoxa-spiro[5.5]undecane is desirable.

### Polyurethane Resin Polymerization Reaction

The above radiation-curable polyurethane resin can be obtained by subjecting an isocyanate compound and a polyol compound to a urethane-forming reaction. The starting materials can be dissolved in a solvent (polymerization solvent); and heating, pressurization, and nitrogen-backfilling can be conducted as needed to facilitate the urethane-forming reaction. The usual reaction conditions for conducting a urethane-forming reaction can be adopted for the reaction temperature, reaction time, and other reaction conditions of the urethane-forming reaction.

As stated above, at least the isocyanate compound or the polyol compound desirably comprises a radiation-curable functional group. When at least the isocyanate compound or the polyol compound comprises a radiation-curable functional group, the isocyanate compound and the polyol compound are desirably reacted in the presence of at least one compound selected from the group consisting of components C and D. This can inhibit progression of a curing reaction by the radiation-curable functional group during the urethane-forming reaction (can inhibit progression of the curing reaction before irradiation with radiation). Either component C or D may be added during the urethane-forming reaction, with component C being desirable. When component C is added during the urethane-forming reaction, component D is desirably added to the resin composition containing the reaction product (radiation-curable polyurethane resin) following the urethane-forming reaction. This can make it possible to stably store the resin composition for extended periods while maintaining curability. The urethane-forming reaction is desirably conducted in the presence of a polymerization catalyst. Known polyurethane resin polymerization catalysts may be employed, such as tertiary amine catalysts and organic tin catalysts. Examples of tertiary amine catalysts are diethylene triamine, N-methylmorpholine, and tetramethylhexamethylene diamine. Examples of organic tin catalysts are dibutyltin dilaurate and tin octoate. The use of an organic tin catalyst is desirable in the present invention. The quantity of catalyst added is, for example, 0.01 to 5 weight parts, desirably 0.01 to 1 weight part, and preferably, 0.01 to 0.1 weight part relative to the total quantity of starting material compounds employed in polymerization.

The polymerization solvent can be selected from among known solvents that are used to synthesize polyurethane resins. Examples are: ketone solvents such as acetone, methyl ethyl ketone, and cyclohexanone; ester solvents such as methyl acetate, ethyl acetate, and ethyl lactate; ether solvents such as dioxane and tetrahydrofuran; aromatic solvents such as toluene and xylene; amide solvents such as N,N-dimethyl formamide, N,N-dimethyl acetamide, and N-methyl pyrrolidone; sulfoxide solvents such as dimethyl sulfoxide; methylene chloride; chloroform; and cyclohexane. The solvent of the resin composition of the present invention can include solvents employed as the above polymerization solvents. The incorporation of methyl ethyl ketone, cyclohexanone, or a mixed solvent thereof, which are widely employed in coating liquids for magnetic recording media, is particularly desirable. Compositions containing these solvents can be employed as the coating liquid for a magnetic recording medium as is or with the addition of optional additives.

Further, when incorporating a side chain into a radiation-curable functional group after polyurethane synthesis, the reaction between the compound containing the radiation-curable functional group and the polyurethane is desirably conducted in the presence of at least one compound selected from the group consisting of components C and D. The compound that is added to the reaction in such cases is desirably component C, with the addition of component D to the resin composition containing the reaction product (radiation-curable polyurethane resin) following the reaction incorporating the radiation-curable polar group into the polyurethane being desirable.

### Radiation-Curable Polyurethane Resin

(a) Average Molecular Weight

The weight average molecular weight of the radiation-curable polyurethane resin contained in the resin composition of the present invention or the radiation-curable polyurethane resin obtained by reacting the above starting material compounds is desirably equal to or higher than 10,000 and equal to or lower than 500,000 (in the present invention, “equal to or higher than 10,000 and equal to or lower than 500,000” may also be denoted as “10,000 to 500,000”; identical below), preferably 10,000 to 400,000, and more preferably, 10,000 to 300,000. A weight average molecular weight of equal to or higher than 10,000 is desirable in that the resulting storage property of the coating layer formed using the radiation-curable polyurethane resin as binder can be good. Further, a weight average molecular weight of equal to or lower than 500,000 is desirable in that good dispersibility can be achieved.

For example, the weight average molecular weight can be adjusted to within the desired range by microadjusting the mole ratio of glycol-derived OH groups to diisocyanate-derived NCO groups and through the use of reaction catalysts. The weight average molecular weight can be further adjusted by adjusting the solid component concentration during the reaction, the reaction temperature, the reaction solvent, the reaction time, and the like.

The molecular weight distribution (Mw/Mn) of the radiation-curable polyurethane resin is desirably 1.00 to 5.50, preferably 1.01 to 5.40. A molecular weight distribution of equal to or lower than 5.50 is desirable in that the composition distribution is low and good dispersibility can be achieved.

(b) Urethane Group Concentration

The urethane group concentration of the radiation-curable polyurethane resin is desirably 2.0 to 5.0 mmole/g, preferably 2.1 to 4.5 mmole/g.

A urethane group concentration of equal to or higher than 2.0 mmole/g is desirable in that the glass transition temperature (Tg) can be high, a coating with good durability can be formed, and dispersibility can be good. A urethane group concentration of equal to or lower than 5.0 mmole/g is desirable in that good solvent solubility can be achieved, the polyol content can be adjusted, and the molecular weight can be readily controlled.

(c) Glass Transition Temperature

The glass transition temperature (Tg) of the radiation-curable urethane resin is desirably 10 to 180° C., preferably 10 to 170° C. A glass transition temperature of equal to or higher than 10° C. is desirable in that a strong coating can be formed by radiation curing and a coating of good durability and storage properties can be obtained. When employing the resin composition of the present invention as a magnetic recording medium coating liquid, the glass transition temperature of the radiation-curable polyurethane resin contained is desirably equal to or lower than 180° C. in that calendering moldability can be good even when calendering is conducted after radiation curing and a magnetic recording medium with good electromagnetic characteristics can be obtained. The glass transition temperature (Tg) of the coating that is formed by radiation curing the radiation-curable polyurethane resin is desirably 30 to 200° C., preferably 40 to 160° C. A glass transition temperature of equal to or higher than 30° C. is desirable in that good coating strength can be achieved and durability and the storage property can be enhanced. A glass transition temperature of equal to or lower than 200° C. in the coating of a magnetic recording medium is desirable in that good calendering moldability and electromagnetic characteristics can be achieved.

(d) Polar Group Content

Polar groups are desirably incorporated into the radiation-curable polyurethane resin as set forth above.

The content of polar groups in the radiation-curable polyurethane resin is desirably 1.0 to 3,500 mmole/kg, preferably 1.0 to 3,000 mmole/kg, more preferably 1.0 to 2,500 mmole/kg.

The concentration of polar groups is desirably equal to or higher than 1.0 mmole/kg in that adequate adsorbability to the magnetic powder can be imparted and dispersibility can be good. The concentration of polar groups is desirably equal to or lower than 3,500 mmole/kg in that good solubility in solvent can be achieved. The polar group is desirably a sulfonic acid (salt) group. As set forth above, the use of a sulfonic acid (salt) group-containing polyol compound denoted by general formula (1) as a starting material compound can make it possible to obtain a radiation-curable polyurethane resin containing a polar group and sulfonic acid (salt) group. Examples of other polar groups are hydroxyalkyl groups, carboxylic acid (salt) groups, sulfuric acid (salt) groups, and phosphoric acid (salt) groups, with —OSO₃M′, —PO₃M′₂, —COOM′, and —OH being desirable. Of these, —OSO₃M′ is preferred. M′ denotes a hydrogen atom or monovalent cation. Examples of monovalent cations are alkali metals and ammonium.

(e) Hydroxyl Group Content

Hydroxyl groups (OH groups) can also be incorporated into the radiation-curable polyurethane resin. The number of OH groups incorporated is desirably 1 to 100,000, preferably 1 to 10,000, per molecule. When the number of hydroxyl groups lies within this range, good dispersion can be achieved due to enhanced solubility in solvent.

(f) Radiation-Curable Functional Group Content

The details of the radiation-curable functional groups contained in the radiation-curable polyurethane resin are as set forth above. The content thereof is desirably 1.0 to 4,000 mmole/kg, preferably 1.0 to 3,000 mmole/kg, and more preferably, 1.0 to 2,000 mmole/kg. A radiation-curable functional group content of equal to or higher than 1.0 mmole/kg is desirable in that a strong coating can be formed by radiation curing. A radiation-curable functional group content of equal to or lower than 4,000 mmole/kg is desirable in that good calendering moldability can be achieved even when calendering is conducted after radiation curing, and a magnetic recording medium with good electromagnetic characteristics can be obtained when the resin composition of the present invention is employed as a magnetic recording medium coating liquid. The present invention can increase the extended storage stability of a radiation-curable polyurethane resin containing a radiation-curable functional group in the above-stated suitable quantity, for example, without loss of curability.

(ii) Component C (Phenol Compound)

Component C in the form of a phenol compound is not specifically limited other than that it comprise a hydroxyphenyl group. The hydroxyphenyl group may be substituted or unsubstituted. Examples of substituents are alkyl groups, alkoxy groups, and hydroxyl groups. The phenol compound may also comprise multiple substituted or unsubstituted hydroxybenzene skeletons (be a polyphenol compound). The polyphenol compound is not specifically limited. From the perspectives of availability and effect, bisphenol A, Irgacure 1010 (made by Ciba Specialty Chemicals), and the like are desirable. Desirable examples of the phenol compound of component C are: p-methoxyphenol, hydroquinone, polyphenol compounds, and 2,6-di-t-butyl-p-cresol. A single phenol compound may be employed alone, or two or more phenol compounds may be employed in combination, as component C.

(iii) Component D

Component D is at least one compound selected from the group consisting of piperidine-1-oxyl groups, nitro compounds, benzoquinone compounds, and phenothiazine compounds. Component D need only be one compound selected from among the above compounds, but two or more such compounds may be employed in combination. From the perspective of achieving a balance between long-term storage stability and curability, component D is desirably a piperidine-1-oxyl compound, nitro compound, or benzoquinone compound, and preferably a piperidine-1-oxyl compound.

The various compounds that are employed as component D will be sequentially described below.

1. Piperidine-1-oxyl Compounds

The piperidine-1-oxyl compound referred to in the present invention means a compound having the piperidine-1-oxyl structure indicated below.

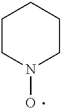

The piperidine-1-oxyl compound can be in the form of a compound comprising a substituted piperidine-1-oxyl skeleton, or an unsubstituted piperidine-1-oxyl compound. Examples of the substituents are alkyl groups, alkoxy groups, amino groups, carboxyl groups, cyano groups, hydroxyl groups, isothiocyanate groups, optionally substituted alkylcarbonylamino groups, arylcarbonyloxy groups, piperidyl ring carbon-containing carbonyl groups, and other substituents contained in Example compounds indicated below. A piperidine-1-oxyl group comprising one piperidine-1-oxyl skeleton or two or more such skeletons may be employed. Examples of desirable piperidine-1-oxyl compounds are Example compounds (1-a) to (1-1) below. Of these, Example compounds (1-f), (1-j), (1-l), (1-b), and (1-k) are desirable, and (1-f), (1-j), (1-l), and (1-b) are preferably, and (1-f), (1-j), and (1-l) are of greater preference.

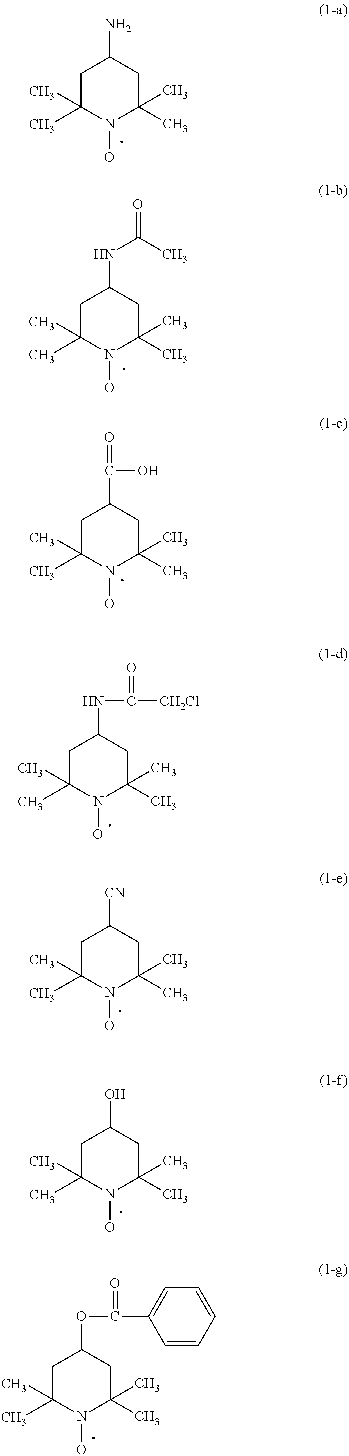

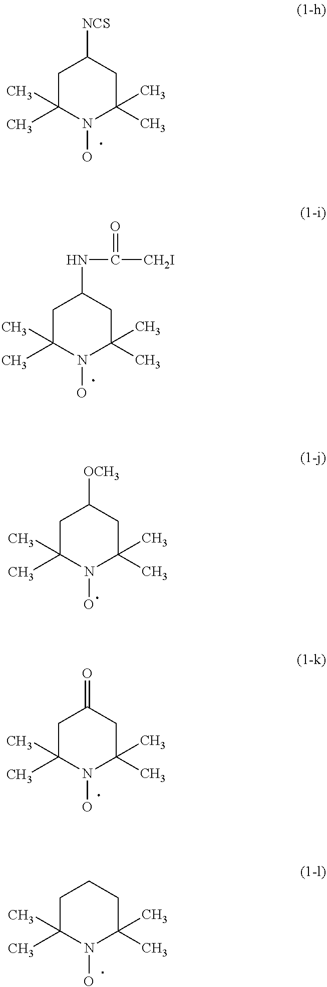

### 2. Nitro Compound

The nitro compound is not specifically limited other than that it be a compound comprising a nitro group denoted by R—NO₂. In this formula, the R moiety is, for example, an aryl group (desirably an aryl group having 6 to 10 carbon atoms, such as a phenyl group) or an alkyl group (desirably an alkyl group having 1 to 12 carbon atoms, such as a methyl group, ethyl group, propyl group, isopropyl group, linear or branched butyl group, linear or branched amyl group, linear or branched hexyl group, linear or branched heptyl group, linear or branched octyl group, linear or branched nonyl group, linear or branched decyl group, linear or branched undecyl group, or linear or branched dodecyl group, and optionally comprising a hetero atom). From the perspective of availability, nitrobenzene and nitromethane are preferred.

### 3. Benzoquinone Compound

The benzoquinone compound is a compound comprising a benzoquinone skeleton. The benzoquinone skeleton contained therein can be the o-benzoquinone skeleton or p-benzoquinone skeleton indicated below.

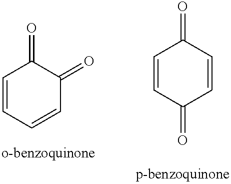

From the perspective of availability, the benzoquinone skeleton is desirably a compound comprising a p-benzoquinone skeleton. The benzoquinone skeleton in the benzoquinone compound may be substituted or unsubstituted. Examples of substituents (which may themselves be substituted) are alkyl groups, alkoxyl groups, hydroxyl groups, halogen atoms, aryl groups, cyano groups, nitro groups, and any of the substituents contained in Example compounds indicated below. Further, the benzoquinone compound employed may have one, two, or more benzoquinone skeletons. Example compounds given below are examples of desirable benzoquinone compounds.

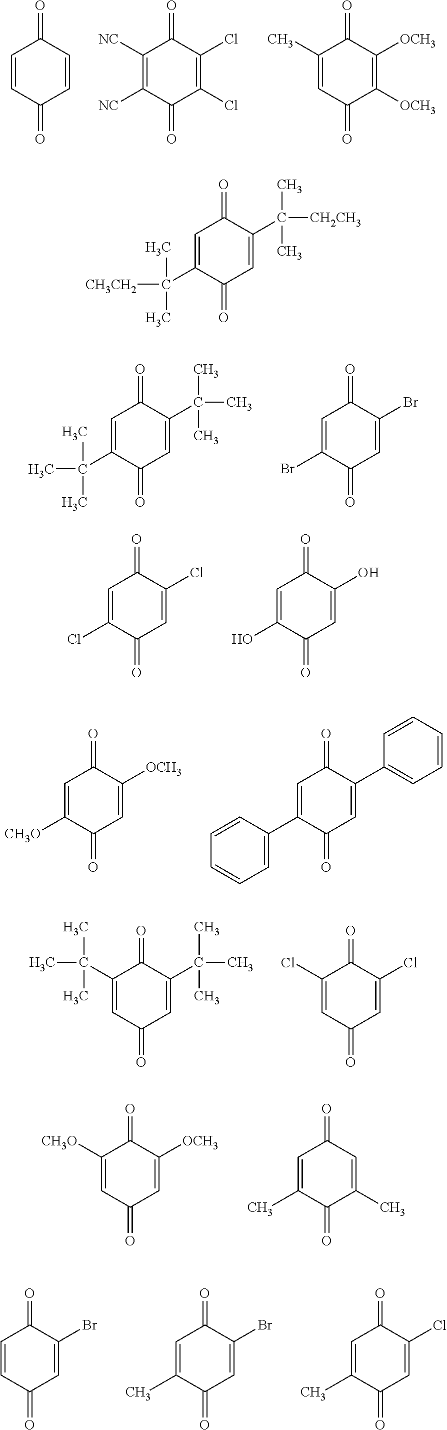

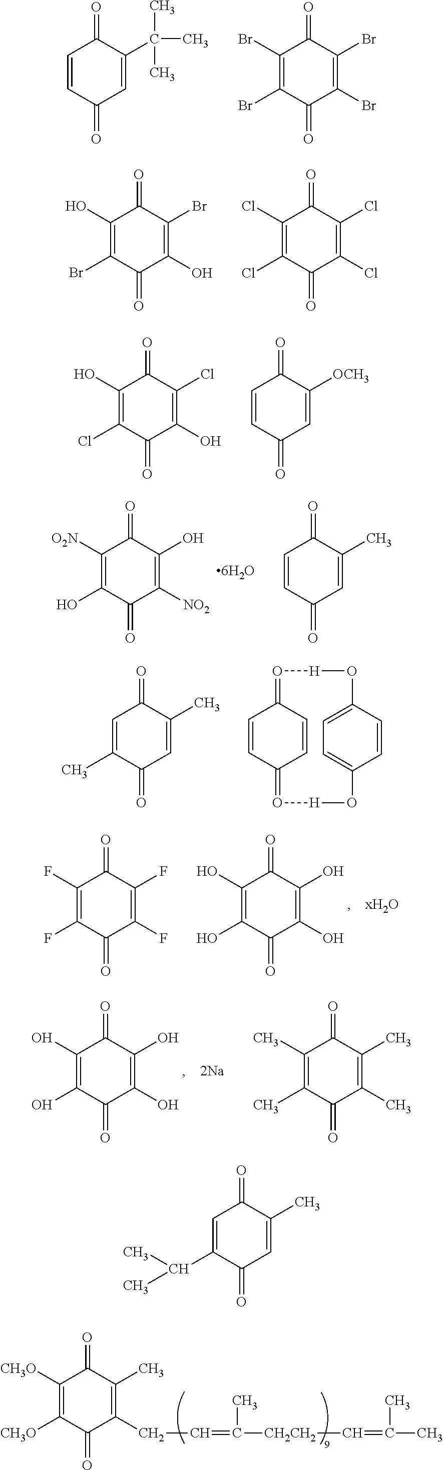

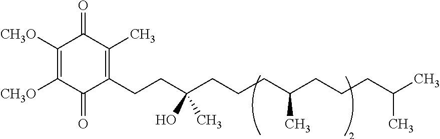

### 4. Phenothiazine Compound

The term “phenothiazine compound” means a compound having the phenothiazine skeleton indicated below.

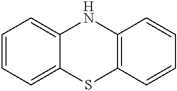

The phenothiazine skeleton contained in the phenothiazine compound may be substituted or unsubstituted. Examples of substituents are halogen atoms, optionally substituted amino groups, alkoxy groups, alkylthio groups, acyl groups, arylcarbonyl groups, trihalomethyl groups, and any of the other substituents contained in Example compounds indicated below.

A phenothiazine compound having one, two, or more phenothiazine skeletons may be employed. Example compounds (4-a) to (4-g) are examples of desirable phenothiazine compounds. Of these, Example compounds (4-b), (4-c), (4-d), (4-e), (4-f), and (4-g) are preferred, (4-b), (4-c), (4-d), (4-e), and (4-f) are of greater preference, and (4-c), (4-d), (4-e), and (4-f) are of even greater preference.

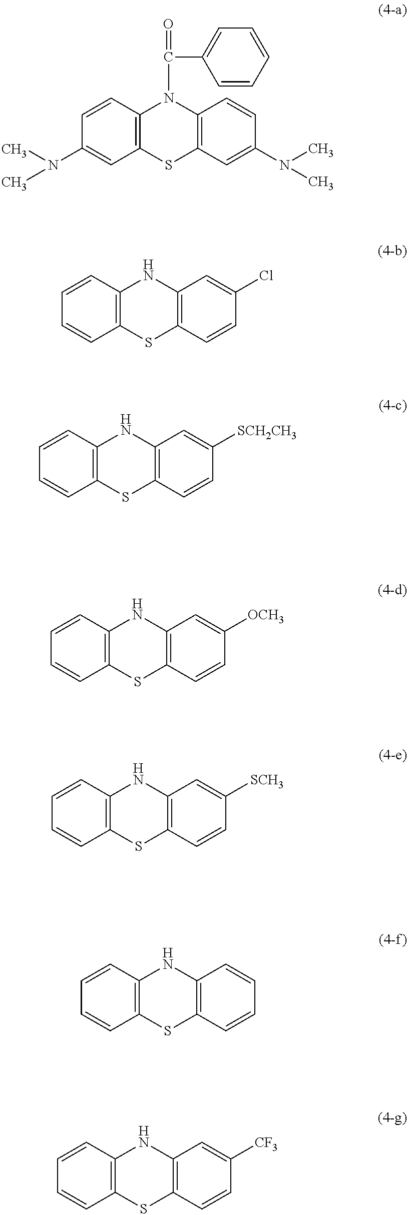

From the perspective of achieving both long-term storage stability and curability, the content of component C in the resin composition of the present invention (the combined content when multiple compounds are employed) is desirably 1 ppm or higher and 500,000 ppm or lower, preferably equal to or higher than 1 ppm and equal to or lower than 400,000 ppm, more preferably equal to or higher than 1 ppm and equal to or lower than 300,000 ppm, and still more preferably, equal to or higher than 500 ppm and equal to or lower than 100,000 ppm relative to the solid component of the radiation-curable polyurethane resin (as converted to the polyurethane solid component obtained when the reaction progresses 100 percent in the resin composition containing the starting material compounds).

Additionally, from the perspective of achieving both long-term storage stability and curability, the content of component D in the resin composition of the present invention (the combined content when multiple compounds are employed) is desirably equal to or higher than 1 ppm and equal to or lower than 500,000 ppm, preferably equal to or higher than 1 ppm and equal to or lower than 400,000 ppm, more preferably equal to or higher than 1 ppm and equal to or lower than 300,000 ppm, and still more preferably, equal to or higher than 1 ppm and equal to or lower than 500 ppm relative to the solid component of the radiation-curable polyurethane resin.

The solid component concentration in the resin composition of the present invention is not specifically limited. Equal to or higher than 10 weight percent is desirable, and a solid component of 100 percent is acceptable. From the perspectives of storage stability and ease of handling, a solid component concentration of about 10 to 80 weight percent is preferred and about 20 to 60 weight percent is of greater preference.

Components C and D can be added simultaneously or sequentially to the composition comprising the starting materials or the radiation-curable polyurethane resin. It is desirable to add some of the components during the synthesis reaction of the radiation-curable polyurethane resin, and to add other components after the synthesis reaction. The components that are added during the synthesis reaction are thought to perform the role of inhibiting the radiation-curable functional groups from reacting during synthesis without loss of curability when irradiated with radiation, and the components that are added after synthesis are thought to play the role, along with the components added during synthesis, of enhancing storage stability without loss of curability when irradiated with radiation. The nitro compounds among component D and component C are desirable as components added during synthesis, and component D is desirable as a component added after synthesis.

The various components that are contained in the radiation-curable polyurethane resin composition of the present invention can be synthesized by known methods or the above-described methods. Some of them are available as commercial products.

### Method of Manufacturing Radiation-Curable Polyurethane Resin Composition

The present invention also relates to a method of manufacturing the radiation-curable polyurethane resin composition of the present invention including the step of conducting a reaction of component A and component B (at least one of which contains a radiation-curable functional group) in the presence of component C. In the manufacturing method of the present invention, component D is desirably admixed with the reaction product (radiation-curable polyurethane resin) obtained by reacting component A and component B in the presence of component C. By inhibiting reaction of the radiation-curable functional group during the urethane-forming reaction in this manner, it is possible to enhance the long-term storage stability of the radiation-curable polyurethane resin without losing curability when irradiated with radiation.

The details of the manufacturing method of the present invention are as set forth above. Reference can also be made to Examples set forth below with regard to specific embodiments. The manufacturing method of the present invention is suitable as a method for manufacturing the radiation-curable polyurethane resin composition of the present invention. However, as set forth above, the radiation-curable polyurethane resin composition of the present invention is not limited to radiation-curable polyurethane resins obtained by the above-described manufacturing method.

### Polyurethane Resin

The present invention further relates to a polyurethane resin obtained by radiation-curing a radiation-curable polyurethane resin composition of the present invention. The radiation that is irradiated to induce the curing reaction can be, for example, an electron beam or ultraviolet radiation. The use of an electron beam is desirable because no polymerization initiator is required. Irradiation with radiation can be conducted by a known method. For the details, see [0021] to [0023] in Japanese Unexamined Patent Publication (KOKAI) No. 2009-134838, which is expressly incorporated herein by reference in its entirety, for example. Further, known techniques such as those described in “UV·EB Curing Techniques” (released by the Sogo Gijutsu Center) and in “Applied Techniques of Low-Energy Electron Beam Irradiation” (2000, released by CMC (Ltd.)) can be employed as the method of curing by irradiation with radiation and the radiation curing device. The contents of the above publications are expressly incorporated herein by reference in their entirety.

### Magnetic Recording Medium

The magnetic recording medium of the present invention comprises a magnetic layer containing a ferromagnetic powder and a binder on a nonmagnetic support, and at least one layer obtained by curing a coating layer containing the radiation-curable polyurethane resin composition of the present invention with radiation.

The radiation-cured layer can be, for example, the magnetic layer. In the magnetic recording medium of the present invention, the magnetic layer and/or the nonmagnetic layer can be the radiation-cured layer when there is a nonmagnetic layer containing a nonmagnetic powder and a binder between the nonmagnetic support and the magnetic layer.

The radiation-curable polyurethane resin composition of the present invention can be in a stable state that changes little over time due to change in the molecular weight of the polyurethane resin during long-term storage. Further, good curability can be maintained even with extended storage. Accordingly, the curing reaction due to irradiation with radiation can progress smoothly and a high-strength radiation-cured layer can be formed even when the above coating layer is formed after storing the radiation-curable polyurethane resin composition of the present invention for an extended period.

The magnetic recording medium of the present invention is described in greater detail below.

### Binder

The polyurethane resin of the present invention, obtained by curing with radiation the radiation-curable polyurethane resin composition of the present invention, is an example of the binder contained in the magnetic layer and nonmagnetic layer. Other binders can be employed in combination with the radiation-curable polyurethane resin of the present invention as the binder contained in the magnetic layer and nonmagnetic layer. Examples of resins that are employed in combination are polyurethane resins other than the polyurethane resin of the present invention; polyester resins; polyamide resins; vinyl chloride resins; acrylic resins copolymerized with styrene, acrylonitrile, methyl methacrylate, or the like; cellulose resins such as nitrocellulose resin; epoxy resins; phenoxy resins; and polyvinyl alkyral resins such as polyvinyl acetal and polyvinyl butyral. When a layer that does not contain the polyurethane resin of the present invention is present, these binders are also examples of binders that can be employed in that layer of the magnetic recording medium of the present invention. Of these binders, the desirable binders are the polyurethane resins, acrylic resins, cellulose resins, and vinyl chloride resins. Reference can be made to [0081] to [0094] in Japanese Unexamined Patent Publication (KOKAI) No. 2009-96798 for details regarding binder resins that can be employed in the magnetic recording medium of the present invention.

From the perspectives of both the fill rate of ferromagnetic powder and the strength of the magnetic layer, the content of binder in the magnetic layer is desirably equal to or more than 5 weight parts and equal to or less than 30 weight parts, preferably equal to or more than 10 weight parts and equal to or less than 20 weight parts, per 100 weight parts of ferromagnetic powder. In the layer containing the polyurethane resin of the present invention as binder, the polyurethane resin of the present invention desirably accounts for equal to or more than 50 weight percent, preferably 60 to 100 weight percent, and more preferably, 70 to 100 weight percent of the total quantity of binder. The same holds true for the quantity of binder employed in the nonmagnetic layer.

### Magnetic Layer

(i) Ferromagnetic Powder

The magnetic recording medium of the present invention comprises a ferromagnetic powder together with a binder, in the magnetic layer. Acicular ferromagnetic powder, platelike magnetic powder, spherical magnetic powder, or elliptical magnetic powder can be employed as the ferromagnetic powder. From the perspective of high-density recording, the average major axis length of the acicular ferromagnetic powder is desirably equal to or greater than 20 nm but equal to or lower than 50 nm and preferably equal to or greater than 20 nm but equal to or lower than 45 nm. The average plate diameter of the platelike magnetic powder is preferably equal to or greater than 10 nm but equal to or less than 50 nm as a hexagonal plate diameter. When employing a magnetoresistive head in reproduction, a plate diameter equal to or less than 40 nm is desirable to reduce noise. A plate diameter within the above range can yield stable magnetization without the effects of thermal fluctuation, and permit low noise, that is suited to the high-density magnetic recording. From the perspective of high-density recording, the average diameter of the spherical magnetic powder or elliptical magnetic powder is desirably equal to or greater than 10 nm but equal to or lower than 50 nm.

In order to improve the dispersibility of microparticulate ferromagnetic powder as described above, it is desirable to use the binder containing polar groups such as those described above. From this perspective, it is preferable to use the binder in the form of the radiation-curable polyurethane resin obtained with the polyol compound denoted by general formula (1) as a starting material, for example.

The average particle size of the ferromagnetic powder can be measured by the following method.

Particles of ferromagnetic powder are photographed at a magnification of 100,000-fold with a model H-9000 transmission electron microscope made by Hitachi and printed on photographic paper at a total magnification of 500,000-fold to obtain particle photographs. The targeted magnetic material is selected from the particle photographs, the contours of the powder material are traced with a digitizer, and the size of the particles is measured with KS-400 image analyzer software from Carl Zeiss. The size of 500 particles is measured. The average value of the particle sizes measured by the above method is adopted as an average particle size of the ferromagnetic powder.

The size of a powder such as the magnetic material (referred to as the “powder size” hereinafter) in the present invention is denoted: (1) by the length of the major axis constituting the powder, that is, the major axis length, when the powder is acicular, spindle-shaped, or columnar in shape (and the height is greater than the maximum major diameter of the bottom surface); (2) by the maximum major diameter of the tabular surface or bottom surface when the powder is tabular or columnar in shape (and the thickness or height is smaller than the maximum major diameter of the tabular surface or bottom surface); and (3) by the diameter of an equivalent circle when the powder is spherical, polyhedral, or of unspecified shape and the major axis constituting the powder cannot be specified based on shape. The “diameter of an equivalent circle” refers to that obtained by the circular projection method.

The average powder size of the powder is the arithmetic average of the above powder size and is calculated by measuring five hundred primary particles in the above-described method. The term “primary particle” refers to a nonaggregated, independent particle.

The average acicular ratio of the powder refers to the arithmetic average of the value of the (major axis length/minor axis length) of each powder, obtained by measuring the length of the minor axis of the powder in the above measurement, that is, the minor axis length. The term “minor axis length” means the length of the minor axis constituting a powder for a powder size of definition (1) above, and refers to the thickness or height for definition (2) above. For (3) above, the (major axis length/minor axis length) can be deemed for the sake of convenience to be 1, since there is no difference between the major and minor axes.

When the shape of the powder is specified, for example, as in powder size definition (1) above, the average powder size refers to the average major axis length. For definition (2) above, the average powder size refers to the average plate diameter, with the arithmetic average of (maximum major diameter/thickness or height) being referred to as the average plate ratio. For definition (3), the average powder size refers to the average diameter (also called the average particle diameter).

Reference can be made to [0097] to [0110] of Japanese Unexamined Patent Publication (KOKAI) No. 2009-96798 for the details of the above-described magnetic powders.

### (ii) Additives

Additives may be added to the magnetic layer as needed. Examples of such additives are: abrasives, lubricants, dispersing agents, dispersing adjuvants, antifungal agents, antistatic agents, oxidation inhibitors, and solvents. Reference can be made to [0111] to [0115] of Japanese Unexamined Patent Publication (KOKAI) No. 2009-96798 for the details, such as specific examples, of the additives.

Carbon black may be added to the magnetic layer as needed. Examples of types of carbon black that are suitable for use in the magnetic layer are: furnace black for rubber, thermal for rubber, black for coloring, and acetylene black. It is preferable that the specific surface area is 100 to 500 m²/g (more preferably 150 to 400 m²/g), the DBP oil absorption capacity is 20 to 400 ml/100 g (more preferably 30 to 200 ml/100 g), the particle diameter is 5 to 80 nm (more preferably 10 to 50 nm), the pH is 2 to 10, the moisture content is 0.1 to 10 percent, and the tap density is 0.1 to 1 g/ml. For example, the Carbon Black Handbook compiled by the Carbon Black Association, which is expressly incorporated herein by reference in its entirety, may be consulted for types of carbon black suitable for use in the magnetic layer. These carbon blacks are commercially available.

The types and quantities of the additives employed in the magnetic layer may differ from those employed in the nonmagnetic layer, described further below, in the present invention. All or some part of the additives employed in the present invention can be added in any of the steps during the manufacturing of coating liquids for the magnetic layer and nonmagnetic layer. For example, there are cases where they are mixed with the ferromagnetic powder prior to the kneading step; cases where they are added during the step in which the ferromagnetic powder, binder, and solvent are kneaded; cases where they are added during the dispersion step; cases where they are added after dispersion; and cases where they are added directly before coating.

### Nonmagnetic Layer

A nonmagnetic layer comprising a nonmagnetic powder and a binder can be provided between the nonmagnetic support and magnetic layer in the magnetic recording medium of the present invention. To increase running durability, the nonmagnetic layer is desirably in the form of the above-described radiation-cured layer.

The nonmagnetic powder can be an organic or inorganic substance. Examples of inorganic substances are: metals, metal oxides, metal carbonates, metal sulfates, metal nitrides, metal carbides, and metal sulfides. Carbon black may also be employed. These nonmagnetic powders are commercially available and can be manufactured by known methods.

Specifically, titanium oxides such as titanium dioxide, cerium oxide, tin oxide, tungsten oxide, ZnO, ZrO₂, SiO₂, Cr₂O₃, α-alumina with an α-conversion rate of 90 to 100 percent, β-alumina, γ-alumina, α-iron oxide, goethite, corundum, silicon nitride, titanium carbide, magnesium oxide, boron nitride, molybdenum disulfide, copper oxide, MgCO₃, CaCO₃, BaCO₃, SrCO₃, BaSO₄, silicon carbide, and titanium carbide may be employed singly or in combinations of two or more. α-iron oxide and titanium oxide are preferred.

The nonmagnetic powder may be acicular, spherical, polyhedral, or plate-shaped.

The crystallite size of the nonmagnetic powder preferably ranges from 4 nm to 1 μm, more preferably from 40 to 100 nm. The crystallite size within 4 nm to 1 μm can achieve good dispersibility and suitable surface roughness.

The average particle diameter of the nonmagnetic powder preferably ranges from 5 nm to 2 μm. As needed, nonmagnetic powders of differing average particle diameter may be combined; the same effect may be achieved by broadening the average particle distribution of a single nonmagnetic powder. The particularly preferred average particle diameter of the nonmagnetic powder ranges from 10 to 200 nm. Reference can be made to [0123] to [0132] of Japanese Unexamined Patent Publication (KOKAI) No. 2009-96798 for the nonmagnetic powder suitable for use in the magnetic recording medium of the present invention.

Carbon black may be combined with nonmagnetic powder in the nonmagnetic layer to reduce surface resistivity, reduce light transmittance, and achieve a desired micro-Vickers hardness. The micro-Vickers hardness of the nonmagnetic layer is normally 25 to 60 kg/mm², desirably 30 to 50 kg/mm² to adjust head contact. It can be measured with a thin film hardness meter (HMA-400 made by NEC Corporation) using a diamond triangular needle with a tip radius of 0.1 micrometer and an edge angle of 80 degrees as indenter tip. The light transmittance is generally standardized to an infrared absorbance at a wavelength of about 900 nm equal to or less than 3 percent. For example, in VHS magnetic tapes, it has been standardized to equal to or less than 0.8 percent. To this end, furnace black for rubber, thermal black for rubber, black for coloring, acetylene black and the like may be employed.

The specific surface area of the carbon black employed in the nonmagnetic layer is desirably 100 to 500 m²/g, preferably 150 to 400 m²/g. The DBP oil absorption capability is desirably 20 to 400 mL/100 g, preferably 30 to 200 mL/100 g. The particle diameter of the carbon black is preferably 5 to 80 nm, preferably 10 to 50 nm, and more preferably, 10 to 40 nm. It is preferable that the pH of the carbon black is 2 to 10, the moisture content is 0.1 to 10 percent, and the tap density is 0.1 to 1 g/mL. For example, the Carbon Black Handbook compiled by the Carbon Black Association, which is expressly incorporated herein by reference in its entirety, may be consulted for types of carbon black suitable for use in the nonmagnetic layer. These carbon blacks are commercially available.

Based on the objective, an organic powder may be added to the nonmagnetic layer. Examples of such an organic powder are acrylic styrene resin powders, benzoguanamine resin powders, melamine resin powders, and phthalocyanine pigments. Polyolefin resin powders, polyester resin powders, polyamide resin powders, polyimide resin powders, and polyfluoroethylene resins may also be employed. The manufacturing methods described in Japanese Unexamined Patent Publication (KOKAI) Showa Nos. 62-18564 and 60-255827 may be employed. The contents of the above publications are expressly incorporated herein by reference in their entirety.

Binder resins, lubricants, dispersing agents, additives, solvents, dispersion methods, and the like suited to the magnetic layer may be adopted to the nonmagnetic layer. In particular, known techniques for the quantity and type of binder resin and the quantity and type of additives and dispersion agents employed in the magnetic layer may be adopted thereto.

### Nonmagnetic Support

A known film such as a biaxially-oriented polyethylene terephthalate, polyethylene naphthalate, polyamide, polyamidoimide, or aromatic polyamide can be employed as the nonmagnetic support. Of these, polyethylene terephthalate, polyethylene naphthalate, and polyamide are preferred.

These supports can be corona discharge treated, plasma treated, treated to facilitate adhesion, heat treated, or the like in advance. The surface roughness of the nonmagnetic support employed in the present invention preferably ranges from 3 to 10 nm, as a center average roughness Ra at a cutoff value of 0.25 mm.

### Smoothing Layer

A smoothing layer can be provided in the magnetic recording medium of the present invention. A “smoothing layer” is a layer for burying protrusions on the surface of the nonmagnetic support. In the case of a magnetic recording medium with a magnetic layer on a nonmagnetic support, it can be positioned between the nonmagnetic support and the magnetic layer, and in the case of a magnetic recording medium with a nonmagnetic layer and a magnetic layer sequentially provided on a nonmagnetic support, it can be positioned between the nonmagnetic support and the nonmagnetic layer.

The smoothing layer can be formed by curing a radiation-curable compound by irradiation with radiation.

The “radiation-curable compound” refers to a compound that has the properties of beginning to undergo polymerization or crosslinking when irradiated with radiation such as ultraviolet radiation or an electron beam, and curing into a polymer. The radiation-curable polyurethane resin composition of the present invention can be employed to form the smoothing layer.

### Backcoat Layer

Generally, a magnetic tape used for computer data recording will be required to have better repeat running properties than a video tape or an audio tape. To maintain such a high degree of storage stability, a backcoat layer can be provided on the opposite surface of the nonmagnetic support from the surface on which the magnetic layer is provided. The backcoat layer coating liquid can be formed by dispersing particulate components such as an abrasive, an antistatic agent, and the like and binder in an organic solvent. Various inorganic pigments, carbon black, and the like can be employed as the particulate components. Resins such as nitrocellulose, phenoxy resin, vinyl chloride resin, and polyurethane can be employed singly or in combination as the binder. The radiation-curable polyurethane resin composition of the present invention can be used to form the backcoat layer.

### Layer Structure

In the magnetic recording medium of the present invention, the thickness of the nonmagnetic support desirably ranges from 3 to 80 μm. When the above smoothing layer is provided between the nonmagnetic support and the nonmagnetic layer or the magnetic layer, the thickness of the smoothing later desirably ranges from 0.01 to 0.8 μm, and preferably 0.02 to 0.6 μm. The thickness of the above backcoat layer is, for example, 0.1 to 1.0 μm, and desirably 0.2 to 0.8 μm.

The thickness of the magnetic layer is desirably optimized based on the saturation magnetization of the head employed, the length of the head gap, and the recording signal band, and is normally 0.01 to 0.10 μm, preferably 0.02 to 0.08 μm, and more preferably, 0.03 to 0.08 μm. The thickness variation in the magnetic layer is preferably within ±50 percent, more preferably within ±40 percent. At least one magnetic layer is sufficient. The magnetic layer may be divided into two or more layers having different magnetic characteristics, and a known configuration relating to multilayered magnetic layer may be applied.

The thickness of the nonmagnetic layer is desirably 0.2 to 3.0 μm, preferably 0.3 to 2.5 μm, and further preferably, 0.4 to 2.0 μm. The nonmagnetic layer is effective so long as it is substantially nonmagnetic. For example, it exhibits the effect of the present invention even when it comprises impurities or trace amounts of magnetic material that have been intentionally incorporated, and can be viewed as substantially having the same configuration as the magnetic recording medium of the present invention. The term “substantially nonmagnetic” is used to mean having a residual magnetic flux density in the nonmagnetic layer of equal to or less than 10 mT, or a coercivity of equal to or less than 7.96 kA/m (100 Oe), it being preferable not to have a residual magnetic flux density or coercivity at all.

### Manufacturing Method

The steps for manufacturing coating liquids for forming the various layers such as the magnetic layer and the nonmagnetic layer desirably include at least a kneading step, dispersing step, and mixing steps provided as needed before and after these steps. Each of these steps may be divided into two or more stages. All of the starting materials such as the ferromagnetic powder, nonmagnetic powder, binder, carbon black, abrasives, antistatic agents, lubricants, solvents and the like that are employed in the present invention can be added at the beginning or part way through any of the steps. Individual starting materials can be divided into smaller quantities and added in two or more increments. For example, the polyurethane can be divided into small quantities and incorporated during the kneading step, dispersing step, and after the dispersing step to adjust the viscosity. The above starting materials can be added simultaneously or successively to the radiation-curable polyurethane resin composition of the present invention to prepare coating liquids. For example, the powder components such as the ferromagnetic powder and nonmagnetic powder can be pulverized in a kneader, the radiation-curable polyurethane resin composition of the present invention (and other binder components optionally employed in combination) can be added to conduct the kneading step, various additives can be added to the kneaded product, and dispersion can be conducted to prepare a coating liquid.

To prepare coating liquids for forming the various layers, conventionally known manufacturing techniques may be utilized for some of the steps. A kneader having a strong kneading force, such as an open kneader, continuous kneader, pressure kneader, or extruder is preferably employed in the kneading step. When a kneader is employed, the binder (preferably equal to or higher than 30 weight percent of the entire quantity of binder) can be kneaded in a range of 15 to 500 parts per 100 parts of the ferromagnetic powder or nonmagnetic powder. Details of the kneading process are described in Japanese Unexamined Patent Publication (KOKAI) Heisei Nos. 1-106338 and 1-79274, which are expressly incorporated herein by reference in their entirety. Further, glass beads may be employed to disperse the coating liquids for magnetic and nonmagnetic layers. Other than glass beads, dispersing media with a high specific gravity such as zirconia beads, titania beads, and steel beads are suitable for use. The particle diameter and fill ratio of these dispersing media can be optimized for use. A known dispersing device may be employed.

In the method of manufacturing a magnetic recording medium of the present invention, for example, a nonmagnetic layer coating liquid can be applied to the surface of a running nonmagnetic support in a quantity calculated to yield a prescribed film thickness to form a nonmagnetic layer. A magnetic layer coating liquid can then be applied thereover in a quantity calculated to yield a prescribed film thickness to form a magnetic layer. Multiple magnetic layer coating liquids can be successively or simultaneously applied in multiple layers, or the nonmagnetic layer coating liquid and the magnetic layer coating liquid can be successively or simultaneously applied in multiple layers. When the lower layer (nonmagnetic layer) coating liquid and the upper layer (magnetic layer) coating liquid are applied successively in multiple layers, the nonmagnetic layer will sometimes partially dissolve into the solvent contained in the magnetic layer coating liquid. When the nonmagnetic layer is a radiation-cured layer, the radiation-curable component in the nonmagnetic layer is polymerized or crosslinked by irradiation with radiation to achieve a high molecular weight, so dissolution into the solvent contained in the magnetic layer coating liquid can be inhibited or reduced. Accordingly, when successively applying the lower nonmagnetic layer coating liquid and the upper magnetic layer coating liquid to form multiple layers, it is desirable to conduct irradiation with radiation before applying the upper magnetic layer coating liquid and then form the magnetic layer over the cured nonmagnetic layer. The nonmagnetic layer coating liquid employed in this case is desirably prepared using the radiation-curable polyurethane resin composition of the present invention.

The coating machine used to apply the magnetic layer coating liquid or nonmagnetic layer coating liquid can be an air doctor coater, blade coater, rod coater, extrusion coater, air knife coater, squeeze coater, dip coater, reverse roll coater, transfer roll coater, gravure coater, kiss coater, cast coater, spray coater, spin coater or the like. Reference can be made to the “Most Recent Coating Techniques” (May 31, 1983) released by the Sogo Gijutsu Center (Ltd.), which are expressly incorporated herein by reference in their entirety, for these coating machines. In the course of forming a radiation-cured layer, the coating layer that has been formed by coating the coating liquid is irradiated with radiation to cure it. The details of the processing by irradiation with radiation are as set forth above. Following the coating step, the medium can be subjected to various post-processing, such as processing to orient the magnetic layer, processing to smoothen the surface (calendering), and thermoprocessing to reduce heat contraction. Reference can be made to [0146] to [0148] of Japanese Unexamined Patent Publication (KOKAI) No. 2009-96798, for example, with regard to this processing. The magnetic recording medium that is obtained can be cut to prescribed size with a cutter, puncher, or the like for use.

### Physical Characteristics

The saturation magnetic flux density of the magnetic layer preferably ranges from 100 to 300 mT (1,000 to 3,000 G). The coercivity (Hr) of the magnetic layer is preferably 143.3 to 318.4 kA/m (1,800 to 4,000 Oe), more preferably 159.2 to 278.6 kA/m (2,000 to 3,500 Oe). Narrower coercivity distribution is preferable. The SFD and SFDr are preferably equal to or lower than 0.6, more preferably equal to or lower than 0.2.

The coefficient of friction of the magnetic recording medium of the present invention relative to the head is desirably equal to or less than 0.50 and preferably equal to or less than 0.3 at temperatures ranging from −10° C. to 40° C. and humidity ranging from 0 percent to 95 percent, and the charge potential preferably ranges from −500 V to +500 V. The modulus of elasticity at 0.5 percent extension of the magnetic layer preferably ranges from 0.98 to 19.6 GPa (100 to 2,000 kg/mm²) in each in-plane direction. The breaking strength preferably ranges from 98 to 686 MPa (10 to 70 kg/mm²). The modulus of elasticity of the magnetic recording medium preferably ranges from 0.98 to 14.7 GPa (100 to 1500 kg/mm²) in each in-plane direction. The residual elongation is preferably equal to or less than 0.5 percent, and the thermal shrinkage rate at all temperatures below 100° C. is preferably equal to or less than 1 percent, more preferably equal to or less than 0.5 percent, and most preferably equal to or less than 0.1 percent.

The glass transition temperature (i.e., the temperature at which the loss elastic modulus of dynamic viscoelasticity peaks as measured at 110 Hz) of the magnetic layer and the nonmagnetic layer is preferably within the desirable range described above for the coating. The loss elastic modulus preferably falls within a range of 1×10⁷ to 8×10⁸ Pa (1×10⁸ to 8×10⁹ dyne/cm²) and the loss tangent is preferably equal to or less than 0.2. Adhesion failure tends to occur when the loss tangent becomes excessively large. These thermal characteristics and mechanical characteristics are desirably nearly identical, varying by equal to or less than 10 percent, in each in-plane direction of the medium.

The residual solvent contained in the magnetic layer is preferably equal to or less than 100 mg/m² and more preferably equal to or less than 10 mg/m². The void ratio in the coated layers, including both the nonmagnetic layer and the magnetic layer, is preferably equal to or less than 30 volume percent, more preferably equal to or less than 20 volume percent. Although a low void ratio is preferable for attaining high output, there are some cases in which it is better to ensure a certain level based on the object. For example, in many cases, larger void ratio permits preferred running durability in disk media in which repeat use is important.

The radiation-curable resin has the property of polymerizing or crosslinking when irradiated with radiation to form a polymer and thus cure. The curing reaction proceeds by irradiation with radiation, so the coating liquid containing the radiation-curable resin is of a relatively low viscosity that remains stable so long as it is not irradiated with radiation. Thus, the coarse protrusions of the support surface can be covered (masked) by the leveling effect until the coating layer is cured. Accordingly, forming a radiation-cured layer can yield a magnetic recording medium of good surface smoothness and good high-density recording and reproduction characteristics. Employing a binder containing a polar group as the binder component as set forth above can increase the dispersibility of powder components such as the ferromagnetic powder and contribute to enhancing the surface smoothness of the magnetic layer. However, when there is a pronounced change in the molecular weight of the radiation-curable resin during a long period of storage, it becomes difficult to achieve a good leveling effect, causing the surface smoothness of the magnetic layer to decrease. By contrast, the long-term storage stability of the resin composition of the present invention can be good, so even when stored for an extended period, a magnetic layer of high surface smoothness can be formed. Additionally, when long-term storage stability and curability are not both present, the durability of the medium may diminish even when good surface smoothness is achieved. By contrast, the resin composition of the present invention is capable of long-term stable storage as set forth above, and can exhibit good curability following long-term storage.

As set forth above, when successively coating the lower nonmagnetic layer coating liquid and upper magnetic layer coating liquid in multiple layers, a portion of the nonmagnetic layer will sometimes dissolve into the solvent contained in the magnetic layer coating liquid. When that the nonmagnetic layer is a radiation-cured layer, dissolution of the nonmagnetic layer into the magnetic layer coating liquid can be inhibited or reduced. As a result, the decrease in smoothness of the magnetic layer due to dissolution of the nonmagnetic layer can be inhibited.

Employing the resin composition of the present invention in a coating liquid for a magnetic recording medium in this manner is advantageous in that a magnetic recording medium of good surface smoothness and durability is achieved, and contributes to enhanced productivity because the resin composition (coating liquid) can be prepared in large-quantity batches and stored for extended periods.

In the magnetic recording medium of the present invention, the center surface roughness Ra of the magnetic layer as measured with a digital optical profilometer (TOPO-3D made by WYKO) is desirably equal to or lower than 4.0 nm, preferably equal to or lower than 3.0 nm, and more preferably, equal to or lower than 2.0 nm. The maximum height of the magnetic layer SRₘₐₓ is desirably equal to or lower than 0.5 μm, the ten point average roughness SR_{z} is desirably equal to or lower than 0.3 μm, and the center surface peak height SRₚ is desirably equal to or lower than 0.3 μm. The center surface valley depth SRᵥ is desirably equal to or lower than 0.3 μm, the center surface area ratio SSᵣ is desirably 20 to 80 percent, and the average wavelength Sλa is desirably 5 to 300 μm. The number of surface protrusions on the magnetic layer with a height of 0.01 to 1 μm can be optionally set to within a range of 0 to 2,000, which is desirable to optimize electromagnetic characteristics and the coefficient of friction. These can be readily controlled by controlling the surface properties by means of the support filler, the particle diameter and quantity of powder that is added to the magnetic layer, the roll surface shape of the calender, and the like. Curling is desirably kept to within ±3 mm.

In the magnetic recording medium of the present invention, physical properties of the nonmagnetic layer and magnetic layer may be varied based on the objective. For example, the modulus of elasticity of the magnetic layer may be increased to improve storage stability while simultaneously employing a lower modulus of elasticity than that of the magnetic layer in the nonmagnetic layer to improve the head contact of the magnetic recording medium.

The head used to reproduce the signal that is magnetically recorded on the magnetic recording medium of the present invention is not specifically limited. An MR head is desirably employed for high-sensitivity reproduction of signals recorded at high density. The MR head that is employed as the reproduction head is not specifically limited. For example, AMR heads, GMR heads, and TMR heads may be employed. The head employed for magnetic recording is not specifically limited. However, the saturation magnetization level of the recording head is desirably equal to or higher than 1.0 T, preferably equal to or higher than 1.5 T, for high-density recording.

### Storage Stabilizer for a Radiation-Curable Polyurethane Resin

The storage stabilizer for a radiation-curable polyurethane resin of the present invention comprises the above component C (a phenol compound) and the above component D (at least one compound selected from the group consisting of a piperidine-1-oxyl compound, a nitro compound, a benzoquinone compound and a phenothiazine compound). Combining components C and D can make it possible to increase storage stability without compromising the curability of the radiation-curable polyurethane resin. For example, the addition of components C and D to a radiation-curable polyurethane resin composition can reduce or inhibit change in the molecular weight of the resin component, thereby enhancing storage stability.

The storage stabilizer of the present invention may be in the form of a single agent such that all the components, including components C and D, are contained in a single agent, or may be in the form of multiple agents such that one or two agents are simultaneously mixed, or two or three agents are sequentially mixed, during use. For example, component C can be added as the first agent to the starting material compounds of a radiation-curable polyurethane resin, with component D being added following polymerization. Component C may be employed in the form of a single phenol compound or in the form of two or more phenol compounds. The same applies to component D. The quantities of components C and D that are employed relative to the radiation-curable polyurethane resin are as given above.

### Examples

The present invention will be described in detail below based on Examples. However, the present invention is not limited to the examples. The “parts” and “percent” given in Examples are weight parts and weight percent unless specifically stated otherwise.

### 1. Synthesis Examples of Polyol Compounds Containing Sulfonic Acid (Salt) Group Denoted by General Formula (1)

### Synthesis Example 1

### Synthesis of Sulfonic Acid (Salt) Group-Containing Diol Compound

### Example Compound (S-1)

To 250 parts of water were added 100 parts of 2-aminoethanesulfonic acid and 33.5 parts of lithium hydroxide monohydrate and the mixture was stirred for 30 minutes at 45° C. To this were added 156 parts of 1,2-butylene oxide and the mixture was stirred for 2 hours at 45° C. After adding 400 parts of toluene and stirring for 10 minutes, the mixture was left standing and the lower layer was separated. The lower layer thus obtained was solidified and dried, yielding lithium salt (S-1) of bis(2-hydroxybutyl)aminoethanesulfonic acid. The ¹H NMR data of (S-1) and their attributions are given below. A 400 MHz NMR (AVANCE II-400 made by BRUKER) was employed for the ¹H NMR measurements recorded below.

(S-1): ¹H NMR (D_{2 l O=}4.75 ppm) δ(ppm)=3.68 (2H, m), 3.10 (2H, m), 2.59 (2H, m), 2.40 (4H, m), 1.45 (4H, m), 0.89 (6H, t).

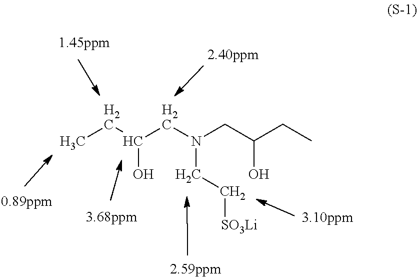

### Synthesis Example 2

### Synthesis of Sulfonic Acid (Salt) Group-Containing Diol Compound

### Example Compound (S-2)

With the exception that the 1,2-butyleneoxide was replaced with butyl glycidyl ether in Synthesis Example 1, a lithium salt (S-2) of bis(2-hydroxy-3-butoxypropyl)aminoethanesulfonic acid was synthesized in the same manner as in Synthesis Example 1. The ¹H NMR data of (S-2) and their attributions are given below.

(S-2): ¹H NMR (D₂ O=4.75 ppm) δ(ppm)=3.84 (2H, m), 3.55-3.30 (8H, m), 3.3 8 (2H, m), 2.95 (4H, m), 2.51 (2H, m), 1.49 (4H, m), 1.27 (4H, m), 0.83 (6H, t).

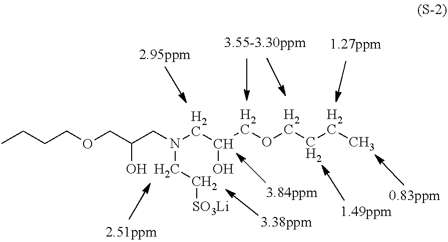

### Synthesis Example 3

### Synthesis of Sulfonic Acid (Salt) Group-Containing Diol Compound

### Example Compound (S-31)

To a flask were charged 100 mL of distilled water, 50 g (0.400 mol) of taurine, and 22.46 g (87 percent purity) of KOH made by Wako Pure Chemical Industries, Ltd. The internal temperature was raised to 50° C. and the contents were thoroughly dissolved.

Next, the internal temperature was cooled to 40° C., 140.4 g (1.080 moles) of butyl glycidyl ether were added dropwise over 30 minutes, the temperature was raised to 50° C., and the mixture was stirred for 2 hours. The solution was cooled to room temperature, 100 mL of toluene was added, the solution was separated, and the toluene layer was discarded. Next, 400 mL of cyclohexanone was added, the temperature was raised to 110° C., and the water was removed with a Dean-Stark apparatus, yielding a 50 percent cyclohexanone solution of sulfonic acid (salt) group-containing diol compound (S-31). The ¹H NMR data of the product are given below. It was determined from the NMR analysis results that the product was a mixture containing other compounds such as Example Compound (S-64) in addition to Example Compound (S-31).

¹H NMR (CDCl3): δ(ppm)=4.5(br.), 3.95-3.80 (m), 3.50-3.30 (m),3.25-2.85 (m), 2.65-2.5 (m), 2.45-2.35 (m), 1.6-1.50 (quintuplet), 1.40-1.30 (sextuplet), 1.00-0.90 (triplet).

### Synthesis Example 4

### Synthesis of Sulfonic Acid (Salt) Group-Containing Diol Compound

### Example Compound (S-3)

The epoxy employed was changed to styrene oxide and the target compound was obtained by the same operations as in Synthesis Example 1.

### Synthesis Example 5

### Synthesis of Sulfonic Acid (Salt) Group-Containing Diol Compound

### Example Compound (S-7)

To 250 parts of water were added 100 parts of m-aminobenzenesulfonic acid and 24 parts of lithium hydroxide monohydrate, and the mixture was stirred for 30 minutes at 45° C. To this were added 112 parts of 1,2-butyleneoxide and the mixture was stirred for another 2 hours at 45° C. After adding 400 parts of toluene and stirring for 10 minutes, the mixture was left standing and the lower layer was separated. The lower layer thus obtained was solidified and dried, yielding the target compound.

### Synthesis Example 6

### Synthesis of Sulfonic Acid (Salt) Group-Containing Diol Compound

### Example Compound (S-8)

The alkali employed was changed to sodium hydroxide and the target compound was obtained by the same operations as in Synthesis Example 5.

### Synthesis Example 7

### Synthesis of Sulfonic Acid (Salt) Group-Containing Diol Compound

### Example Compound (S-9)

The alkali employed was changed to potassium hydroxide and the target compound was obtained by the same operations as in Synthesis Example 5.

### Other Synthesis Examples

Example compounds (S-10) to (S-74) were synthesized by the same operations as in Synthesis Example 1. Among Example Compounds (S-10) to (S-74), the sulfonic acid-containing diol compounds that did not contain salts were obtained by using a strongly acidic ion-exchange resin (Amberlite IR1120H made by Aldrich) to remove the alkali metal ions from a solution comprising one part of the corresponding sulfonate diol compound and 5 parts of cyclohexanone.

### 2. Examples and Comparative Examples of the Radiation-Curable Polyurethane Resin Composition (Resin Solution)

### Example 1

To a flask were charged 52.87 g (concentration 355.32 mmole/kg) of 4,4′-(propane-2,2-diyl)diphenol methyloxylane adduct (BPX-1000 made by Adeka, weight average molecular weight 1,000), 6.35 g of glycerol methacrylate (Bremmer GLM made by NOF Corporation), 12.48 g of dimethylol tricyclodecane (TCDM made by OXEA) as a chain-extending agent, 1.70 g of sulfonic acid (salt) group-containing diol compound (Example Compound (S-72)) as a polar-group incorporating component, 101.36 g of cyclohexanone as a polymerization solvent, and 0.232 g of p-methoxyphenol as compound C. Next, a solution of 42.66 g of methylene bis(4,1-phenylene)=diisocyanate (MDI) (Millionate MT made by Nippon Polyurethane Industry Co., Ltd.) and 52.73 g of cyclohexanone was added dropwise over 15 minutes. A polymerization catalyst in the form of 0.348 g of di-n-butyltin laurate was added, the temperature was raised to 80° C., and the mixture was stirred for 3 hours. When the reaction had ended, 116.69 g of cyclohexanone was added, yielding a polyurethane resin solution. After synthesizing the urethane, to the polyurethane resin solution obtained was added 100 ppm of p-benzoquinone relative to the polyurethane solid component as component D.

The solid component of the polyurethane resin solution obtained by the above steps was 30 percent. Within one day of preparing the above polyurethane resin solution, the weight average molecular weight (Mw) and number average molecular weight (Mn) of the polyurethane resin contained in the solution were measured by the method described further below, revealing Mw=38,000 and Mn=24,000. Measurement by the method described further below of the sulfonic acid (salt) group content of the polyurethane resin revealed 69.55 mmole/kg. No residual monomer was detected by GPC, so the content of radiation-curable functional groups was calculated to be 355.32 mmole/kg from the charge ratio.

### Example 2

To a flask were charged 57.50 g of 4,4′-(propane-2,2-diyl)diphenol methyloxylane adduct (BPX-1000 made by Adeka, weight average molecular weight 1,000) as a chain-extending agent, 6.50 g of glycerol methacrylate (Bremmer GLM made by NOF Corporation) (concentration 355.44 mmole/kg), 10.50 g of methylol tricyclodecane (TCDM made by OXEA), 3.40 g of sulfonic acid (salt) group-containing diol compound (Example Compound (S-31)) as a polar-group incorporating component, 107.66 g of cyclohexanone as a polymerization solvent, and 0.240 g of p-methoxyphenol as compound C. Next, a solution of 42.21 g of methylene bis(4,1-phenylene)=diisocyanate (MDI) (Millionate MT made by Nippon Polyurethane Industry Co., Ltd.) and 51.47 g of cyclohexanone was added dropwise over 15 minutes. A polymerization catalyst in the form of 0.361 g of di-n-butyltin laurate was added, the temperature was raised to 80° C., and the mixture was stirred for 3 hours. When the reaction had ended, 121.28 g of cyclohexanone was added, yielding a polyurethane resin solution. After synthesizing the urethane, to the polyurethane resin solution obtained was added 50 ppm of 4-hydroxy-2,2,6,6-tetramethylpiperidine-N-oxyl (4-OH-TEMPO) relative to the polyurethane solid component as component D.

The solid component of the polyurethane resin solution obtained by the above steps was 30 percent. Measurement of the weight average molecular weight (Mw), number average molecular weight (Mn), and sulfonic acid (salt) group content of the polyurethane resin contained in the solution by the methods described further below revealed Mw=36,000, Mn=24,000, and a sulfonic acid (salt) group content of 69.66 mmole/kg. No residual monomer was detected by GPC, so the content of radiation-curable functional groups was calculated to be 355.44 mmole/kg from the charge ratio.

### Examples 3 to 7

With the exceptions that the sulfonic acid (salt) group-containing diol, component C, and component D employed were changed as indicated in Table 1, polyurethane resin solutions were obtained by the same method as in Example 2. In Examples 3 to 6, no residual monomer was detected by GPC, so the content of radiation-curable functional groups was calculated to be 355.32 mmole/kg from the charge ratio. The sulfonic acid (salt) group content of the polyurethane resins obtained in Examples 3 to 6 as measured by the method described further below was 69.55 mmole/kg. Nor was any residual monomer found in Example 7 by GPC, so the content of radiation-curable functional groups was calculated to be 360.76 mmole/kg from the charge ratio. Further, the content of sulfonic acid (salt) groups in the polyurethane resin obtained in Example 7 as measured by the method set forth further below was 6.66 mmole/kg. The results of measurement by the method set forth further below of the weight average molecular weight (Mw) of the polyurethane resins in the solutions of the Examples are given in Table 1.

### Comparative Example 1

With the exception that no 4-hydroxy-2,2,6,6-tetramethylpiperidine-N-oxyl (4-OH-TEMPO) (component D) was added to the polyurethane resin solution obtained following urethane synthesis, a polyurethane resin solution was obtained by the same method as in Example 2. The results of measurement by the method set forth further below of the weight average molecular weight (Mw) of the polyurethane resin in the polyurethane resin solution obtained are given in Table 1.

### Comparative Example 2

With the exceptions that urethane synthesis was conducted in the presence of benzoquinone (component D) instead of p-methoxyphenol (component C) and no component C or D was added following urethane synthesis, a polyurethane resin solution was obtained by the same method as in Example 2. The results of measurement by the method set forth further below of the weight average molecular weight (Mw) of the polyurethane resin in the polyurethane resin solution obtained are given in Table 1.

### Comparative Example 3

With the exception that the quantity of benzoquinone was increased to ten times the original quantity, a polyurethane resin solution was obtained by the same method as in Comparative Example 2. The results of measurement by the method set forth further below of the weight average molecular weight (Mw) of the polyurethane resin in the polyurethane resin solution obtained are given in Table 1.

### Evaluation Methods

(1) Measurement of Average Molecular Weight

The average molecular weight (Mw, Mn) of the polyurethane resins contained in the various polyurethane resin solutions of Examples and Comparative Examples were obtained as standard polystyrene conversions by gel permeation chromatography (GPC) employing DMF solvent containing 0.3 percent lithium bromide.

(2) Sulfonic Acid (Salt) Group Concentration

The quantity of sulfur was determined from the peak area of sulfur (S) by fluorescence X-ray analysis and converted to the quantity of sulfur corresponding to one kg of polyurethane resin to obtain the concentration of sulfonic acid (salt) groups in the polyurethane resin.

(3) Evaluation of Storage Stability

The polyurethane resin solutions obtained in the Examples and comparative examples were stored at 53° C. under sealed conditions and the number of days required to exhibit a change in the molecular weight as determined by GPC was recorded.

(4) Evaluation of Radiation Curability

The various polyurethane resin solutions obtained in Examples and Comparative Examples were diluted to about 20 percent solid component concentration to prepare test solutions. Each test solution was then coated with a blade (300 μm) on an aramid base and dried for two weeks at room temperature to obtain a coating film 30 to 50 μm in thickness.

The coating film was then irradiated three times with an electron beam with an intensity of 10 kG for a total of 30 kG using an electron beam irradiator.

Next, the film that had been irradiated with the electron beam was immersed in 100 mL of tetrahydrofuran and extracted for 2 hours at 60° C. Following completion of extraction, the film was washed with 100 mL of THF and vacuum dried for 3 hours at 140° C. Next, the weight of the extracted (and dried) film residue was adopted as the weight of the gelled component and the value calculated as (gelled component/weight of coating film prior to extraction)×100 was adopted as the gelling rate, which is given in Table 1. The higher the gelling rate, the better the coating strength and the higher the degree to which radiation curing progressed.

TABLE 1

| | | | | Component added | Component added | | | |
|---|---|---|---|---|---|---|---|---|
| | | | | at polyurethane | following polyurethane | | | |
| | | | | synthesis | synthesis | | | |
| | | | | (Concentration in the | (Concentration in the | Polyurethane evaluation results | | |
| | | | | parenthesis is the | parenthesis is the | Weight | | |
| | Polyol compound | | | concentration added | concentration added | average | | |
| | Polar-group | | | relative to | relative to | molecular | Stability | Curability |
| | incorporating | | Isocyanate | polyurethane | polyurethane | weight | over | (gelling |
| | component | Chain-extending agent | compound | solid component.) | solid component.) | (Mw) | time | rate) |
| Ex. 1 | Ex. | (1)4,4′-(propane- | MDI | p-methoxyphenol | Benzoquinone | 38,000 | 250 days | 80% |
| | Compound | 2,2-diyl)diphenol | | (2000 ppm) | (100 ppm) | | or more | |
| | (S-72) | methyloxylane adduct | | | | | | |
| | | (2) Glycerol methacrylate | | | | | | |
| | | (3) Dimethylol tricyclodecane | | | | | | |
| Ex. 2 | Ex. | (1)4,4′-(propane- | MDI | p-methoxyphenol | 4-hydroxy-2,2,6,6- | 36,000 | 250 days | 85% |
| | Compound | 2,2-diyl)diphenol | | (2000 ppm) | tetramethylpiperidine- | | or more | |
| | (S-31) | methyloxylane adduct | | | N-oxyl (50 ppm) | | | |
| | | (2) Glycerol methacrylate | | | | | | |
| | | (3) Dimethylol tricyclodecane | | | | | | |
| Ex. 3 | Ex. | (1)4,4′-(propane- | MDI | p-methoxyphenol | Nitrobenzene | 36,000 | 250 days | 80% |
| | Compound | 2,2-diyl)diphenol | | (2000 ppm) | (30 ppm) | | or more | |
| | (S-31) | methyloxylane adduct | | | | | | |
| | | (2) Glycerol methacrylate | | | | | | |
| | | (3) Dimethylol tricyclodecane | | | | | | |
| Ex. 4 | Ex. | (1)4,4′-(propane- | MDI | Polyphenol^{note} ²⁾ | 2.2.6.6- | 35,000 | 250 days | 85% |
| | Compound | 2,2-diyl)diphenol | | (2000 ppm) | tetramethylpiperidine- | | or more | |
| | (S-31) | methyloxylane adduct | | | N-oxyl (100 ppm) | | | |
| | | (2) Glycerol methacrylate | | | | | | |
| | | (3) Dimethylol tricyclodecane | | | | | | |
| Ex. 5 | Ex. | (1)4,4′-(propane- | MDI | Hydroquinone | (1)Phenothiazine | 34,000 | 185 days | 90% |
| | Compound | 2,2-diyl)diphenol | | (500 ppm) | (1000 ppm) | | | |
| | (S-31) | methyloxylane adduct | | | (2)Hydroquinone | | | |
| | | (2) Glycerol methacrylate | | | (1000 ppm) | | | |
| | | (3) Dimethylol tricyclodecane | | | | | | |
| Ex. 6 | Ex. | (1)4,4′-(propane- | MDI | 2,6-di-t-butyl-4- | nitromethane | 35,000 | 250 days | 80% |
| | Compound | 2,2-diyl)diphenol | | hydroxytoluene | (200 ppm) | | or more | |
| | (S-31) | methyloxylane adduct | | (5000 ppm) | | | | |
| | | (2) Glycerol methacrylate | | | | | | |
| | | (3) Dimethylol tricyclodecane | | | | | | |
| Ex. 7 | Polyester | (1)4.4′-(propane- | MDI | p-methoxyphenol | 4-hydroxy-2,2,6,6- | 36,000 | 250 days | 75% |
| | A^{note 1)} | 2,2-diyi)diphenol | | (2000 ppm) | tetramethylpiperidine- | | or more | |
| | | methyloxylane adduct | | | N-oxyl (500 ppm) | | | |
| | | (2) Glycerol methacrylate | | | | | | |
| | | (3) Dimethylol tricyclodecane | | | | | | |
| Comp. | Ex. | (1)4,4′-(propane- | MDI | p-methoxyphenol | None | 36,000 | 7 days | 75% |
| Ex. 1 | Compound | 2,2-diyl)diphenol | | (2000 ppm) | | | | |
| | (S-31) | methyloxylane adduct | | | | | | |
| | | (2) Glycerol methacrylate | | | | | | |
| | | (3) Dimethylol tricyclodecane | | | | | | |
| Comp. | Ex. | (1)4,4′-(propane- | MDI | Benzoquinone | None | 33,000 | 3 days | 75% |
| Ex. 2 | Compound | 2,2-diyl)diphenol | | (200 ppm) | | | | |
| | (S-31) | methyloxylane adduct | | | | | | |
| | | (2) Glycerol methacrylate | | | | | | |
| | | (3) Dimethylol tricyclodecane | | | | | | |
| Comp. | Ex. | (1)4,4′-(propane- | MDI | Benzoquinone | None | 36,000 | 250 days | 5% |
| Ex. 3 | Compound | 2,2-diyl)diphenol | | (2000 ppm) | | | or more | |
| | (S-31) | methyloxylane adduct | | | | | | |
| | | (2) Glycerol methacrylate | | | | | | |
| | | (3) Dimethylol tricyclodecane | | | | | | |

^{Note 1)}Polyester A: sodium sulfoisophthalate/2,2,-dimethyl-1,3-propanediol = 1/2 mole reaction product (Molecular weight: 4500)
^{Note 2)}Polyphenol: Irgacure 1010

### Evaluation Results

As shown in Table 1, in Comparative Examples 1 and 2, in which just component C or just component D was employed, despite good curability, the stability over time was markedly lower than in Examples. In Comparative Example 3, in which the quantity of component D was ten times that of Comparative Example 2, the stability over time was higher, but the gelling rate of the cured film obtained by irradiation with radiation was low. From these results, it will be understood that the addition of a large quantity of just component D in order to heighten the storage stability resulted in a loss of curability.

By contrast, in Examples 1 to 7, in which components C and D were employed in combination, the polyurethane resin solutions exhibited good stability over time. In contrast to the drop in curability when a component was normally added to increase the long-term storage stability in the manner of Comparative Example 3, the gelling rate of the cured films obtained by irradiation with radiation in Examples 1 to 7 were high and curability was good.

These results show that the combined use of components C and D increased the storage stability without loss of curability in the radiation-curable polyurethane resin compositions.

### 3. Examples and Comparative Examples of Magnetic Recording Media Example 8

<Preparation of Magnetic Layer Coating Liquid>

One hundred parts of acicular ferromagnetic micropowder (average major axis length 35 nm) were pulverized for 10 minutes in an open kneader, 15 parts of the polyurethane resin solution of Example 1 based on the solid component were added, and the mixture was kneaded for 60 minutes. To the kneaded product were added 2 parts of abrasive (Al₂O₃, particle size 0.3 μm), 2 parts of carbon black (particle size 40 μm), and 200 parts of a mixed solution of methyl ethyl ketone/toluene=1/1. The mixture was dispersed for 360 minutes in a sand mill.

To the dispersion obtained were added 2 parts of butyl stearate, 1 part of stearic acid, and 50 parts of cyclohexanone. The mixture was stirred for another 20 minutes and passed through a filter having an average pore diameter of 1 μm to prepare a magnetic layer coating liquid.

<Preparation of Nonmagnetic Layer Coating Liquid>

Eighty-five parts of α-Fe₂O₃ (average diameter 0.15 μm, S_{BET} 52 m²/g, surface treated with Al₂O₃ and SiO₂, pH 6.5 to 8.0) were comminuted for 10 minutes in an open kneader. Next, 7.5 parts of a compound (SO₃Na=6×10⁻⁵ eq/g, epoxy=10⁻³ eq/g, Mw 30,000) obtained by adding hydroxyethyl sulfonate sodium salt to a copolymer in the form of vinyl chloride/vinyl acetate/glycidyl methacrylate=86/9/5; 10 parts based on the solid component of the polyurethane resin solution of Example 2; and 60 parts of cyclohexanone were added and the mixture was kneaded for 60 minutes. To the kneaded product were added 200 parts of a mixed solvent of methyl ethyl ketone/cyclohexanone=6/4, and the mixture was dispersed for 120 minutes in a sand mill.

To the dispersion obtained were added 2 parts of butyl stearate, 1 part of stearic acid, and 50 parts of methyl ethyl ketone and the mixture was stirred for another 20 minutes. The mixture was then passed through a filter with an average pore diameter of 1 μm to prepare a nonmagnetic layer coating liquid.

<Preparation of Magnetic Recording Medium>

An adhesive layer in the form of sulfonic acid-containing polyester resin was applied with a coil bar in a quantity calculated to yield a dry thickness of 0.1 μm on the surface of a polyethylene terephthalate support 7 μm in thickness.

Next, the nonmagnetic layer coating liquid that had been obtained was coated to a dry thickness of 1.5 μm on the adhesive layer to form a coating layer. The coating layer was then irradiated with a 30 kG electron beam to form a nonmagnetic layer (radiation-cured layer). Immediately thereafter, the above magnetic layer coating liquid was applied in a quantity calculated to yield a dry thickness of 0.1 μm on the nonmagnetic layer that had been formed. The nonmagnetic support on which the magnetic layer coating liquid had been applied was subjected to magnetic field orientation with 0.5 Tesla (5,000 Gauss) Co magnets and 0.4 Tesla (4,000 Gauss) solenoid magnets while the magnetic layer coating liquid was still wet. Subsequently, the coating layer of the magnetic layer coating liquid was irradiated with a 30 kG electron beam to form a magnetic layer (radiation-cured layer). Next, calendering was conducted with a seven-stage metal roll combination at a speed of 100 m/minute, a linear pressure of 300 kg/cm, and a temperature of 90° C., after which the product was slit to a ½ inch width (17.7 mm) to obtain a magnetic tape.

### Example 9

With the exception that the polyurethane resin solution of Example 2 was replaced with the polyurethane resin solution of Example 7 during preparation of the nonmagnetic layer coating liquid, a magnetic tape was prepared by the same method as in Example 8.

### Example 10

With the exception that the acicular ferromagnetic micropowder (average major axis length of 35 nm) was replaced with hexagonal platelike ferrite micropowder (average plate diameter of 10 nm) during preparation of the magnetic layer coating liquid, a magnetic tape was prepared by the same method as in Example 8.

### Comparative Example 4

With the exceptions that the polyurethane resin solution of Example 1 was replaced with the polyurethane resin solution of Comparative Example 1 during preparation of the magnetic layer coating liquid and the polyurethane resin solution of Example 2 was replaced with the polyurethane resin solution of Comparative Example 1 during preparation of the nonmagnetic layer coating liquid, a magnetic tape was prepared by the same method as in Example 8.

### Evaluation Methods

The magnetic tapes of Examples 8 to 10 and Comparative Example 4 were evaluated as set forth below. The results are given in Table 2.

### (1) Surface Smoothness of Magnetic Layer

A 30×30 micrometer area was scanned at a tunnel current of 10 nA and a bias current of 400 mV with a Nanoscope II may be Digital Instruments to determine the number of protrusions 10 to 20 nm in height, which was expressed as a relative value adopting Comparative Example 4 as 100.

### (2) Electromagnetic Characteristics (S/N Ratio)

The S/N ratio of each magnetic tape was measured in a fixed-head, ½-inch linear system. The relative velocity of the head/tape was set to 10 m/second. Recording was conducted with an MIG head (track width 18 μm) with a saturation magnetization of 1.4 T. The recording current was set to the optimal current for the individual tape. An anisotropic MR (A-MR) head with a shield gap of 0.2 μm and an element thickness of 25 nm was employed as the reproduction head.

A signal was recorded at a recording wavelength of 0.2 μm, and the frequency of the reproduced signal was analyzed with a spectrum analyzer made by ShibaSoku. The ratio of the output of the carrier signal (wavelength 0.2 μm) to the noise integrated over the entire spectral range was adopted as the S/N ratio, which was expressed as a relative value adopting Comparative Example 4 as 0 dB.

### (3) Repeat Sliding Durability

In a 40° C. 10 percent RH environment, the magnetic layer surface was brought into contact with a round rod of AlTiC, a 100 g load (T1) was applied, and 10,000 repeat sliding passes were made at a sliding rate of 2 m/s, at which point the damage to the tape was observed visually and by optical microscopy (magnification: 100 to 500-fold). An evaluation was then made based on the following scale.

Excellent: Some scratching visible, but mostly unscratched portions present.

Good: More scratched portions than unscratched portions.

Poor: Complete separation of magnetic layer.

### (4) Storage Property

A 600 m length of tape was wound on the reels of an LTO-G3 cartridge and stored at 60° C. and 90 percent RH for two weeks. Following storage, the sliding durability of the tape was measured by the same method as in (3) above.

TABLE 2

| | | Surface | Electromagnetic | Repeat sliding | Storage |
|---|---|---|---|---|---|
| | Polyurethane resin solution | smoothness | characteristics | durability | property |
| Ex. 8 | Magnetic layer: Ex. 1 | 80 | 0.7 | Excellent | Excellent |
| | Nonmagnetic layer: Ex. 2 | | | | |
| Ex. 9 | Magnetic layer: Ex. 1 | 90 | 0.7 | Excellent | Excellent |
| | Nonmagnetic layer: Ex. 7 | | | | |
| Ex. 10 | Magnetic layer: Ex. 1 | 85 | 0.7 | Excellent | Excellent |
| | Nonmagnetic layer: Ex. 2 | | | | |
| Comp. Ex. 4 | Magnetic layer: Comp. Ex. 1 | 100 | 0 | Poor | Poor |
| | Nonmagnetic layer: Comp. Ex. 1 | | | | |

### Evaluation Results

As shown in Table 2, the magnetic tapes of Examples 8 to 10 exhibited much better results in all evaluation categories than the magnetic tape of Comparative Example 4. The present inventors made the following inferences based on these results.

The reason the magnetic tapes of Examples 8 to 10 exhibited such good smoothness was that the magnetic layer coating liquid was applied after curing the nonmagnetic layer with radiation, thereby inhibiting interlayer mixing due to dissolution of the nonmagnetic layer into the magnetic layer coating liquid. The curability of the radiation-curable polyurethane resin employed as the nonmagnetic layer binder was good, so the forming of a strong coating by irradiation with radiation also contributed to inhibiting interlayer mixing. Further, the improvement in dispersibility due to the sulfonic acid (salt) groups contained in the binder of the nonmagnetic layer and magnetic layer was also thought to be a factor in enhanced smoothness. The good electromagnetic characteristics exhibited by the magnetic tapes of Examples 8 to 10 were attributed to good magnetic layer surface smoothness, as set forth above.

The reason for the good repeat sliding durability of the magnetic tapes of Examples 8 to 10 was the fact that a strong coating could be formed due to the good curability of the radiation-curable polyurethane resin employed in the magnetic layer.

When curing of the nonmagnetic layer was inadequate, the amount of nonmagnetic layer components migrating to the magnetic layer side increased. When curing of the magnetic layer was inadequate, large quantities of the various components seeped out onto the magnetic layer surface. When such phenomena occurred, the tape stuck together during storage, precipitates formed on the surface of the tape, and the like, thereby compromising the storage property. In the magnetic tapes of Examples 8 to 10, both the magnetic layer and nonmagnetic layer exhibited good radiation curability and good storage properties.

From the results of Tables 1 and 2 above, it was revealed that the present invention could maintain good storage stability for extended periods in radiation-curable polyurethane resins without loss of curability when irradiated with radiation.

The magnetic recording medium of the present invention can exhibit good durability and storage properties, and is thus suitable as a backup tape for which good repeat running durability and storage properties are required.

Although the present invention has been described in considerable detail with regard to certain versions thereof, other versions are possible, and alterations, permutations and equivalents of the version shown will become apparent to those skilled in the art upon a reading of the specification and study of the drawings. Also, the various features of the versions herein can be combined in various ways to provide additional versions of the present invention. Furthermore, certain terminology has been used for the purposes of descriptive clarity, and not to limit the present invention. Therefore, any appended claims should not be limited to the description of the preferred versions contained herein and should include all such alterations, permutations, and equivalents as fall within the true spirit and scope of the present invention.

Having now fully described this invention, it will be understood to those of ordinary skill in the art that the methods of the present invention can be carried out with a wide and equivalent range of conditions, formulations, and other parameters without departing from the scope of the invention or any embodiments thereof.

All patents and publications cited herein are hereby fully incorporated by reference in their entirety. The citation of any publication is for its disclosure prior to the filing date and should not be construed as an admission that such publication is prior art or that the present invention is not entitled to antedate such publication by virtue of prior invention.

What is claimed is:

1. A radiation-curable polyurethane resin composition comprising a polyurethane resin containing a radiation-curable functional group, and/or starting material compounds thereof, as well as component C in the form of a phenol compound, and component D in the form of at least one compound selected from the group consisting of a piperidine-1-oxyl compound, a nitro compound, a benzoquinone compound and a phenothiazine compound.

2. The radiation-curable polyurethane resin composition according to claim 1, wherein the starting material compounds comprise component A in the form of an isocyanate compound and component B in the form of a polyol compound, with at least one of components A and B containing a radiation-curable functional group.

3. The radiation-curable polyurethane resin composition according to claim 1, wherein the radiation-curable functional group is a (meth)acryloyloxy group.

4. The radiation-curable polyurethane resin composition according to claim 2, wherein component B comprises a polyol compound with a radiation-curable functional group.

5. The radiation-curable polyurethane resin composition according to claim 2, wherein component B comprises a polyol with a sulfonic acid (salt) group.

6. The radiation-curable polyurethane resin composition according to claim 5, wherein the polyol with a sulfonic acid (salt) group is denoted by the following general formula (1): 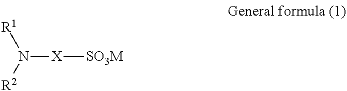
wherein, in general formula (1), X denotes a divalent linking group; each of R¹ and R² independently denotes an alkyl group containing at least one hydroxyl group and equal to or more than two carbon atoms or an aralkyl group containing at least one hydroxyl group and equal to or more than eight carbon atoms; and M denotes a hydrogen atom or a cation.

7. The radiation-curable polyurethane resin composition according to claim 1, which comprises component C in a quantity of equal to or higher than 500 ppm but equal to or lower than 100,000 ppm and component D in a quantity of equal to or higher than 1 ppm but equal to or lower than 500 ppm, relative to the polyurethane resin.

8. The radiation-curable polyurethane resin composition according to claim 1, which is used as a coating liquid for forming a magnetic recording medium or used for preparing the coating liquid.

9. A method of manufacturing a radiation-curable polyurethane resin composition, wherein
the radiation-curable polyurethane resin composition is the radiation-curable polyurethane resin composition according to claim 2, and
the method comprises conducting a reaction of component A and component B in the presence of component C.

10. The method of manufacturing according to claim 9, which further comprises mixing a product of the reaction with component D.

11. A polyurethane resin obtained by radiation-curing a radiation-curable polyurethane resin composition, wherein the radiation-curable polyurethane resin composition is the radiation-curable polyurethane resin composition according to claim 1.

12. A magnetic recording medium comprising a magnetic layer containing a ferromagnetic powder and a binder on a nonmagnetic support, which comprises at least one radiation-cured layer obtained by radiation-curing a coating layer comprising a radiation-curable polyurethane resin composition, the radiation-curable polyurethane resin composition being the radiation-curable polyurethane resin composition according to claim 1.

13. The magnetic recording medium according to claim 12, wherein the radiation-cured layer is the magnetic layer.

14. The magnetic recording medium according to claim 12, which comprises a nonmagnetic layer containing a nonmagnetic powder and a binder between the nonmagnetic support and the magnetic layer, the nonmagnetic layer being the radiation-cured layer.

15. The magnetic recording medium according to claim 12, wherein the starting material compounds contained in the radiation-curable polyurethane resin composition comprise component A in the form of an isocyanate compound and component B in the form of a polyol compound, with at least one of components A and B containing a radiation-curable functional group.

16. The magnetic recording medium according to claim 12, wherein the radiation-curable functional group is a (meth)acryloyloxy group.

17. The magnetic recording medium according to claim 15, wherein component B comprises a polyol compound with a radiation-curable functional group.

18. The magnetic recording medium according to claim 15, wherein component B comprises a polyol with a sulfonic acid (salt) group.

19. The magnetic recording medium according to claim 18, wherein the polyol with a sulfonic acid (salt) group is denoted by the following general formula (1): 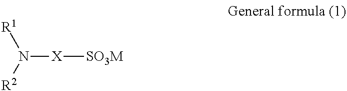
wherein, in general formula (1), X denotes a divalent linking group; each of R¹ and R² independently denotes an alkyl group containing at least one hydroxyl group and equal to or more than two carbon atoms or an aralkyl group containing at least one hydroxyl group and equal to or more than eight carbon atoms; and M denotes a hydrogen atom or a cation.

20. The magnetic recording medium according to claim 12, wherein the radiation-curable polyurethane resin composition comprises component C in a quantity of equal to or higher than 500 ppm but equal to or lower than 100,000 ppm and component D in a quantity of equal to or higher than 1 ppm but equal to or lower than 500 ppm, relative to the polyurethane resin.
